(19) United States
(12) Patent Application Publication
(10) Pub. No.: US 2014/0237378 A1
(43) Pub. Date: Aug. 21, 2014

(54) SYSTEMS AND METHOD FOR IMPLEMENTING MULTIPLE PERSONAS ON MOBILE TECHNOLOGY PLATFORMS

(71) Applicant: Cellrox, Ltd., Tel Aviv (IL)

(72) Inventors: Offir GONEN, Ramat Hasharon (IL); Ranit R. FINK-ISAACS, Beit Arif (IL); Oren LAADAN, New York, NY (US); Alexander Edward VAN'T HOF, New York, NY (US)

(73) Assignee: Cellrox, Ltd., Tel Aviv (IL)

(21) Appl. No.: 14/262,307

(22) Filed: Apr. 25, 2014

Related U.S. Application Data
(63) Continuation of application No. PCT/IB2012/002601, filed on Oct. 29, 2012.
(60) Provisional application No. 61/552,192, filed on Oct. 27, 2011.

(51) Int. Cl. G06F 3/0484; G06F 3/0481; G06F 3/0482; G06F 3/0488

(52) U.S. Cl. CPC G06F 3/0484; G06F 3/0488; G06F 3/04817; G06F 3/0482
USPC 715/745

(57) ABSTRACT

A mobile technology platform equipped with a display and a processor is provided. The platform comprises an operating system executed by the processor; and a software program configured to run on the operating system, wherein the software program is further configured to establish a plurality of personas for a user of the mobile technology platform, wherein each of the plurality of personas has a unique set of user preferences associated with a persona, each of the unique set of user preferences corresponds to a unique execution environment, wherein the software program is further configured to establish a first display portion comprising a first persona environment and a second display portion comprising a second persona environment, wherein the first and second persona execution environments do not overlap.

### CROSS-REFERENCE TO RELATED APPLICATIONS

This application is a continuation application of International Application No. PCT/IB2012/002601, filed on Oct. 29, 2012, which claims the benefit of U.S. Provisional Application Ser. No. 61/552,192, filed on Oct. 27, 2011, the contents of which are incorporated herein by reference.

### FIELD OF THE DISCLOSURE

The present disclosure relates generally to mobile communications and mobile computational devices, and more particularly to systems and methods for implementing multiple personas or configurations on such devices.

### BACKGROUND OF THE DISCLOSURE

Mobile communications and mobile computing devices are used in various settings for various types of tasks. Frequently, it is desirable for the user of such a device to adopt various identities while using the device, often based on the role the user is currently playing. For example, the user may be utilizing the device for both personal and business use, and hence has the need to switch between these identities at different times.

In light of the foregoing, some systems have been developed to allow the user to switch between different identities. For example, U.S. Pat. No. 7,086,008 (Capps, et al) discloses computer-based systems which allow the user to adopt one of many identities, depending upon the particular role that the user is currently undertaking. The computer system includes a central repository of extensible identities which are available to all applications running on the computer system. Each identity has associated therewith a suite of parameters, or specific values for parameters, which are appropriate for conducting transactions in that particular identity.

The computer system of Capps et al. further provides a graphical user interface which allows the user to switch from one role or identity to another by simply selecting a particular identity from a list of available identities displayed on a display screen of the computer system. By selecting a particular identity, the user causes the computer system to globally change the entire suite of parameter values so that subsequent transactions conducted with the computer system employ the parameter values associated with the current identity.

In preferred embodiments of the system of Capps et al., the suite of parameters associated with a particular identity can be extended by applications running on the computer system. Specifically, various applications may add certain role-specific parameters to the system's identities as required.

Capps et al. also discloses various techniques for changing the current identity adopted by the computer system. In accordance with one such technique, the user is allowed to select one of the identities listed on the display menu or list which was described above. Capps et al. notes that, in a pen-based computer system, this is preferably accomplished by determining when a user has tapped on a displayed identity with a stylus. In another technique disclosed in the reference, the current identity is determined by (1) identifying a password input by the user; (2) matching the password to one of the multiple identities available on the computer system; and (3) specifying, as the current identity, the identity associated with the input password.

### BRIEF DESCRIPTION OF THE DRAWINGS

FIGS. 1-2 are illustrations of a system in accordance with the teachings herein which utilizes a persona toolbar in the notification drawer and the use of different status bar background colors or border properties to distinguish between multiple personas.

FIGS. 3-4 are illustrations of a system in accordance with the teachings herein which utilizes a persona toolbar and the use of different icons and status bar background colors to distinguish between multiple personas.

FIG. 5 is an illustration of a system in accordance with the teachings herein which utilizes a breathing effect (moderate blinking) in the background color of the persona icon to indicate the presence of an unread notification.

FIG. 6 is an illustration of a system in accordance with the teachings herein which utilizes static color as an indicator in the background color of the persona icon to indicate the presence of an unread notification.

FIG. 7 is an illustration of a system in accordance with the teachings herein which utilizes a scheme for switching between personas that utilizes (a) a toolbar pop up under the status bar; and/or (b) a full window application or activity with thumbnail images of all of the persona's states.

FIG. 8 is an illustration of a system in accordance with the teachings herein which utilizes a tab slide notification scheme for distinguishing between notifications corresponding to different personas.

FIG. 9 is an illustration of a system in accordance with the teachings herein which utilizes a tabbed status bar which allows the viewing of notifications for multiple personas simultaneously.

FIG. 10 is an illustration of a system in accordance with the teachings herein which utilizes a pull down option on the status bar to reveal a persona switch control panel in the notification drawer.

FIG. 11 is an illustration of a system in accordance with the teachings herein wherein tapping on the background persona reveals a status bar area which switches the persona to the foreground with an animation.

FIG. 12 is an illustration of a system in accordance with the teachings herein which utilizes tab slide notification for foreground and background notifications.

FIG. 13 is an illustration of a system in accordance with the teachings herein which utilizes a tabbed status bar notification drawer for the purposes of making the persona toolbar more discoverable.

FIG. 14 is an illustration of a system in accordance with the teachings herein which utilizes a contracted tabbed status bar in a multiple persona environment; pressing and holding the contracted area expands the tabs to reveal the individual personas.

FIG. 15 is an illustration of a system in accordance with the teachings herein which utilizes a knobbed status bar in a multiple persona environment.

FIG. 16 is an illustration of a first embodiment of a feedback system in accordance with the teachings herein.

FIG. 17 is an illustration of a second embodiment of a feedback system in accordance with the teachings herein.

FIG. 18 is an illustration of a first embodiment of an alert system in accordance with the teachings herein.

FIG. 19 is an illustration of a second embodiment of an alert system in accordance with the teachings herein.

FIGS. 20-24 are illustrations of embodiments of application distribution systems in accordance with the teachings herein.

FIGS. 25-27 are illustrations of embodiments of methods for creating application shortcuts in an application distribution system in accordance with the teachings herein.

FIGS. 28-29 are illustrations of embodiments of in-application persona content systems in accordance with the teachings herein.

FIGS. 30-32 are illustrations of embodiments of systems for interfacing with hardware resources in accordance with the teachings herein.

FIG. 33 is an illustration of an embodiment of a system for managing device settings in accordance with the teachings herein.

FIG. 34 is an illustration of an embodiment of a system in accordance with the teachings herein in which two personas can be active on one screen using a split screen, and in which user(s) may interact with both at the same time.

FIG. 35 is an illustration of an embodiment of a system in accordance with the teachings herein in which the user may move between a single screen persona and a split screen persona through simple hand gestures (spread and pinch gestures).

FIG. 36 is an illustration of an embodiment of a system in accordance with the teachings herein in which two personas may be active on a single screen using a persona in persona thumbnail view, and in which user(s) may interact with both at the same time.

FIG. 37 is an illustration of an embodiment of a system in accordance with the teachings herein in which moving from single screen persona to a persona in persona screen mode may be accomplished through a simple hand gesture (a long press on the status bar).

FIG. 38 is an illustration of a mobile technology platform equipped with a status bar which is disposed at the top of the display.

FIGS. 39-48 illustrate changes which occur in the status bar of a mobile technology platform during the implementation of an embodiment of a method in accordance with the teachings herein.

FIGS. 49-50 depict a notification center with pending messages for different personas.

FIG. 51-52 illustrate different methods for persona browsing.

FIG. 53 illustrates three different methods for unlocking a persona from a lock screen.

FIG. 54 illustrates methods for unlocking a persona from a lock screen.

FIG. 55 illustrates a method for same-application switching in which the switching option is presented in the notification center area and, by selecting the option, the persona switch occurs and the same application is launched in that persona.

FIG. 56 illustrates a method for same-application switching.

FIG. 57 illustrates the implementation of persona tabs on a tablet device.

FIG. 58 illustrates the implementation of persona tabs on a tablet device, where each persona has pending notifications.

FIG. 59 illustrates persona partitioning.

FIG. 60 illustrates an implementation of embedded personas.

### SUMMARY OF THE DISCLOSURE

In one aspect, a mobile technology platform is provided which is equipped with a display and which comprises an operating system or hypervisor; and a software program which runs on said operating system or hypervisor and which establishes a plurality of personas for a user of the mobile technology platform, wherein each of said plurality of personas has a unique set of user preferences associated with it, and wherein said software program establishes a selectable region on the display which allows a user to toggle between said plurality of personas. In some embodiments, toggling may be achieved instead, or in addition, through the use of hardware buttons or other non-display external triggers such as, for example, voice recognition, physical dongles and radio signals.

In another aspect, a mobile technology platform is provided which is equipped with a display and which comprises an operating system or hypervisor; and a software program which runs on said operating system or hypervisor and which establishes first and second configurations for the operating system or hypervisor, wherein said software program is configured to establish a selectable region on the display which allows a user to toggle between said first and second configurations. In some embodiments, toggling may be achieved instead, or in addition, through the use of hardware buttons or other non-display external triggers such as, for example, voice recognition, physical dongles and radio signals.

In a further aspect, a method is provided for implementing multiple personas in a mobile technology platform equipped with a display and an operating system or hypervisor. The method comprises establishing a plurality of personas for a user of the mobile technology platform, wherein each of said plurality of personas has a unique set of user preferences associated with it; and establishing a selectable region on the display which allows a user to toggle between said plurality of personas.

In still another aspect, a mobile technology platform is provided which is equipped with a display and which comprises an operating system or hypervisor; and a software program which runs on said operating system or hypervisor and which establishes a plurality of personas for a user of the mobile technology platform, wherein each of said plurality of personas has a unique set of user preferences associated with it, and wherein said software program establishes a first display portion comprising a first persona environment and a second display portion comprising a second persona environment.

In any of the foregoing aspects, the associated method steps may be implemented as a software program which is disposed in a tangible, non-transient medium associated with the mobile technology platform. Such a software program may contain suitable programming instructions which, when executed, cause the method to be carried out.

### DETAILED DESCRIPTION

As used herein, the term “persona” refers to a role or identity associated with and assumable by a user within a system that has multiple roles or identities which are associated with and assumable by the user, and wherein each of these roles or identities corresponds to a unique execution environment. The execution environment may be a virtual execution environment. Specific examples of execution environments include, but are not limited to, operating systems, sandboxes, userspace containers, and hypervisors.

As used herein, the term “execution environment” refers to the union of a set of applications accessible by a persona with a set of data associated with such applications, and execution services.

As used herein, the terms “active” and “foreground,” when used in reference to a persona, refer to a persona whose associated applications or data (or a subset thereof) form the predominant portion of the content displayed on the screen on a mobile technology platform.

As used herein, the terms “passive” and “background”, when used in reference to a persona, refer to a persona whose associated applications or data (or a subset thereof) do not form the predominant portion of the content displayed on the screen on a mobile technology platform.

While the prior art system, such as disclosed in Capps et al, referenced above, may be suitable for its intended purpose, it also has a number of shortcomings. For example, the roles or identities assumed by the user in Capps et al. occur within the context of an otherwise monolithic system. Hence, Capps et al. features a single system in which these identities or roles are merely utilized to present different views of data contained within the system. Moreover, in the system of Capps et al., when a particular identity is not assumed by the system, that identity becomes idle or suspended, and hence does not play a role in the system.

However, there is a need in the art for a paradigm in which different roles or identities assumed by the user are associated with different systems that may or may not share data. These systems may be, for example, different execution environments in which the programs available, and/or the data on which these programs operate, differ among the various user roles or identities. Such roles or identities are hereinafter referred to as “personas” when they occur in a system having multiple roles or identities defined for a user, and when each of those roles or identities is matched to a distinct execution environment. In this context, an execution environment shall refer to the programs available to a given role or identity, and/or the data on which those programs operate (for the sake of completeness, it is to be noted that Capps et al. also utilizes the term “persona”, but uses the term to refer to different roles or identities associated with a user in the context of a single execution environment).

There is also a need in the art for a system in which the different personas may be active (e.g., displayed) or passive (e.g., hidden) at any given time, and in which the passive personas, though not displayed, may still undertake certain activities in the background (such as, for example, the generation of notifications or modification of its state).

There is further a need in the art for systems and methodologies for implementing persona awareness and notification in mobile technology platforms. In particular, there is a need in the art for a system in which the user is aware of the persona in which the user operates in every state of the device, in which switching between the personas is clear and easily accessible in every state of the device, and in which the active persona accurately reflects background persona notifications.

There is also a need in the art for improved feedback in mobile technology platforms. In particular, there is a need for a system in which feedback gathering is swift, easy and requires minimal unnecessary interaction with the user. There is further a need for such a system which can be implemented within the confines of mobile device limitations (which typically include small screens and keyboards), which focuses on gathering information, and which minimizes categorization and titling.

There is further a need in the art for improved alerts in mobile technology platforms.

There is also a need in the art for improved application distribution in mobile technology platforms. In particular, there is a need in the art for a system in which any application has the ability to be launched from any persona, in which applications can have exclusive content across different personas, and in which applications can share content across personas.

Similarly, there is a need in the art for a system in which some applications may be available only in some personas (that is, in which some applications are not shared). In particular, there is a need in the art for a system which may be configured to launch or suggest (e.g., in a displayed list) equivalent or related applications when the functionality reflected in an application is required by a persona that the application is not shared with (e.g., the Gmail application may be substituted for the email application).

There is further a need in the art for mobile technology platforms featuring multiple personas which provide efficient interaction with hardware resources (such as, for example, hardware elements that provide single hardware service to applications, such as USB connections, audio input/output, BLUETOOOTH® connectivity, NFC (near-field communication, a short-range wireless connectivity standard) and GPS). In particular, there is a need in the art for systems and methodologies in which switching between personas does not stop or disable any hardware service at work (such as, for example, syncing files, playing music, phone calls, and the like), and in which all hardware resources share the same settings across all personas (such as, for example, volume, screen brightness, and the like) unless otherwise specified.

There is also a need in the art for improved device setting ability in mobile technology platforms. In particular, there is a need in the art for a system in which the user has the ability to apply different device settings for each persona, and in which some device settings may be shared across all personas.

There is further a need in the art for improvements with respect to screen locking in mobile technology platforms.

The foregoing needs may be met with the systems and methodologies disclosed herein.

### BACKGROUND

Systems and methodologies are described herein that may be used to manage a plurality of personas on a mobile technology platform. Many of these systems and methodologies utilize the concept of active and passive personas, which may also be referred to as foreground and background personas, respectively.

In particular, in some embodiments of the systems and methodologies described herein, a user may be permitted to interact with a single persona at any given time (termed the “active” or “foreground” persona), while other personas (termed the “passive” or “background” personas) may be running in the background concurrently. In other embodiments of the systems and methodologies described herein, a user may be permitted to interact with two or more personas at any given time. In the latter embodiments, multiple personas are active, and may share the display (typically in a side-by-side manner or with one persona embedded within another).

The active personas (the personas running in the foreground) are the only personas the user can interact with (as, for example, by using applications or activities associated with these personas) at any given moment. The background personas run in the background, and the user may not interact with them, or may only interact with them to a limited extent. However, applications and services associated with a background persona may still run in the background. For example, the user may be composing an email in the active persona while still listening to music playing in the background persona. Moreover, background personas may generate alerts and display notifications of new events or messages, which may be communicated to, and displayed by, the foreground personas.

### Persona Tabs

In the systems and methodologies described herein, personas may be mapped to tabs in the status bar area of the mobile device. Preferably, each persona has a single tab associated with it.

Each tab may have an icon indicating the persona it represents. For example, a personal persona (that is, a persona designated for personal use) may be represented by an icon in the shape of a house, while a business persona (that is, a persona designated for business use) may be represented by and an icon in the shape of a briefcase. Various other visual indicators may be utilized in a persona tab representing a persona including, but not limited to, various shapes, sizes, colors, patterns and images.

### Active Persona Indicator

Various visual indicators may be utilized in the systems and methodologies described herein to distinguish active and background personas from each other. For example, in some embodiments, active personas may be opaque, while background personas may have some level of transparency. In other embodiments, the tab icon of active personas may be provided with a saturated color, while the tab icons of background personas may be provided with a grey-scale color scheme. In still other embodiments, the tab icons of active personas may have a larger size or intensity than the tab icons of background personas.

### Persona Switching

Switching between personas in the systems and methodologies described herein typically involves changing the state of a persona from background to foreground. This may be accomplished in a variety of ways. For example, switching may be accomplished through an appropriate finger gesture, as by tapping on the tab of a background persona. Switching may also be accomplished by using a hardware button or combination of buttons, such as double-clicking on the home button of the mobile technology platform.

For mobile technology platforms equipped with an onscreen device navigation bar, switching may also be accomplished using appropriate finger gestures, such as swiping inside the device navigation bar. Switching may also be accomplished in such devices by using an external trigger, such as, for example, using NFC, Bluetooth, sound, image recognition (e.g., fingerprints), or a physical dongle connected with, or in proximity to, the mobile technology platform.

Another method for switching between personas involves the use of generic buttons, icons, or gestures to transition to “next” and “previous” personas. When a background persona becomes active, it preferably takes over the main screen area and displays the persona's most recent state (if multiple personas are active, each will take over the respective area allocated to it). For example, if a background persona had been running an e-mail application when it previously transitioned to the background, then it will overwrite the display with its e-mail application display, in the same state it was before becoming active.

### Non-Visible Persona Tabs

Some embodiments of the systems and methodologies described herein may include background personas that do not have a corresponding tab representation, or whose corresponding tab representation becomes invisible under certain conditions. In such embodiments, invisible persona tabs may (re)appear and become visible in response to various triggers including, without limitation, a suitable user gesture or manipulation, or in response to a certain usage pattern. For example, a persona tab may become invisible if it is the least frequently used persona, or if it remained unused for a certain period of time.

In some embodiments of the systems and methodologies described herein, persona tabs may become invisible if they do not have any pending notifications, or as a result of explicit user settings made through a system setting facility. Also, in some embodiments, users may be able to set rules to determine whether a given persona tab should be visible or not. For example, the user may decide that a persona tab is hidden if it has not been used for a certain amount of time, or if the persona has no pending notifications to display.

Similarly, in some embodiments of the systems and methodologies described herein, persona tabs may (re)appear in accordance with certain rules. For example, a persona tab may appear when a new pending notification awaits for that persona. A persona tab may also reappear according to preset rules (such as, for example, during certain times of the day), it may reappear based on the geographic location of the mobile technology platform, or it may reappear when a certain radio signal is within range. For example, the user may provide a rule that a gaming persona (a persona intended to offer games, usually to children) tab appears only in evenings and on the weekend. As another example, the business persona may appear only during working hours.

The state of persona tabs may be explicitly toggled between visible and invisible states in response to user gestures. Such gestures may include, for example, swiping a finger on the status bar area in one direction or another (e.g., from left to right, or from right to left).

### Persona Notifications

In a preferred embodiment of the systems and methodologies described herein, each visible persona tab initially contains only the persona icon. When notifications are generated for a persona, they are preferably displayed in the corresponding persona tab. For example, the tab area for that persona may expand to contain the notification icons. If a persona has multiple pending notifications, its corresponding tab may extend to contain the personal persona icon, followed by the number of pending notification icons.

### Persona Notification Drawer Tabbing

Some mobile technology platforms, such as those equipped with the Android operating system, support central notification display that shows notification messages in the main area of the screen. In this display mode with the notification center open, switching to another persona may not only display the most recent state of that newly active persona, but may also display the notification center of the persona overlaid on top of it. In other words, such a switch preserves the user's intent to examine the pending notification messages in the new context.

In addition, when the notification center display is extended to the main area of the screen display, all non-visible persona tabs may appear in the status area. For example, if the system is equipped with personal, business, and gaming personas, only the first two may be visible. However, when the notification center is opened, the nonvisible gaming persona tab may appear in the status bar area as well.

Furthermore, the use of certain gestures—such as, for example, dragging downward or long-pressing on a persona tab area—may open the notification center for that particular persona. By way of illustration, in a system with two visible persona tabs such as an active personal persona and a background business persona, a gesture such as dragging downward from the business persona tab to the bottom edge of the screen may display the notification center screen of the business persona.

### Persona Browsing

In some embodiments of the systems and methodologies described herein, a persona browser may be provided as a further method for switching between personas (in addition to use of personas tabs). A persona browser control may appear in response to a particular user gesture or set of gestures in the status bar area or elsewhere. Such a gesture may be, for example, a long press in the status bar area, which is preferably at least 0.5 seconds, more preferably at least 0.75 seconds, and most preferably at least 1 second. In the persona browser control, the most recent active persona is preferably visually highlighted. This may be achieved, for example, by positioning the persona in the center of the main screen area, or by using other visual methods such as color saturation, enhanced border, opacity, or the like.

In the persona browser control, the user may select a persona and trigger a switch to that persona, thus causing that persona to become the active persona and to expand to the entire screen area. Selecting the persona may be achieved by using a suitable gesture or set of gestures on the persona thumbnail such as, for example, a tap, a swipe (upwards or downwards) or a pinch. Persona browsers may also appear (possibly in response to a user gesture) in locked screen mode, for instance, when the device screen is turned on and the screen starts in locked mode. This feature may be useful when it is desired to be able to switch between personas without unlocking the current persona or without knowing the password/pin-code.

### Persona Browser—Carousel

Various browser controls may be utilized in the systems and methodologies described herein. One such browser control is in a carousel form. Such a carousel persona browser displays scaled down thumbnail images of each persona in a suitable layout, such as, for example, a vertical or horizontal layout. The thumbnail images preferably display the most recent screenshots for each persona, along with the persona icon, and optionally any pending notification icons.

In a horizontal carousel layout, each persona thumbnail is laid out horizontally such that at least one persona image thumbnail is displayed fully or partially in the main screen area. Similarly, in a vertical carousel layout, each persona thumbnail is laid out vertically such that at least one persona image thumbnail is displayed fully or partially in the main screen area. If not all persona thumbnails fit in the main area display, suitable scrolling gestures (such as, for example, finger swiping in a particular direction) may reveal additional persona thumbnails.

### Persona Browser—Cascade

Another persona browser control that may be utilized in the systems and methodologies described herein is in a cascaded layout. The cascaded persona browser preferably displays scaled down thumbnail images of each persona which are laid out as if they were one behind the other or one under the other, thus revealing some portion of the persona image thumbnail. The thumbnail image preferably displays the most recent screenshot for each persona, along with the persona icon and, optionally, any pending notification icons.

### Same Application Switching

It is sometimes desirable for users to switch from one application in one persona to the same application in another persona. For example, a user looking at the contacts application in one persona may want to browse the contacts application in another persona in search of a specific person. Likewise, a user running an e-mail application in a personal persona may realize that she meant to open the e-mail in the business persona.

Same application switching is a method for switching from the active persona that may be utilized to address this use-case. Through the use of this method, if the active persona was running an application in the foreground before the switch, then after the switch the same application will be launched in the new active persona.

In some embodiments of the systems and methodologies described herein, same application switching may be performed by launching a modified “recent activities screen” before switching. This “recent activities screen” will display apart from the standard list of recent activities in the original persona—a suggestion to launch the same application in another persona, if such an application is available in that persona. Once the user selects that item, a switch to that persona occurs with the suggested application.

In other embodiments of the systems and methodologies described herein, same application switching may be performed by launching a modified “notification center screen” before switching. This “notification center screen” will display apart from the existing list of notifications in the corresponding persona, a suggestion to launch the same application in another persona, if such an application is available in that persona.

In still other embodiments of the systems and methodologies described herein, a suggestion to switch to the same application in another persona may appear when the persona browser is launched. In such embodiments, for each persona which has the same (or equivalent, or related) application installed, a suggestion may be displayed to launch the same application in that persona. This suggestion will preferably appear in the vicinity of the persona thumbnail image.

In addition to the specialized methods to suggest same application switching, standard switching methods (such as, for example, through the status bar or persona browsers, or by double clicking on the home button) may be extended to provide same application switching functionality through suitable modification to the gesture involved.

For example, where a standard switch can be accomplished by tapping the respective persona tab in the status bar, a long tap on the same persona tab may be utilized to implement a same application switch. Likewise, a double click on the home button while holding the second click long may be utilized for a similar effect. This approach is particularly desirable on systems such as the Android system, because a long tap on the home button conjures the recent activities screen which similarly allows users quick access to recent activities.

Preferably, in the same application switching methods described herein, if the same application is not available in the target persona, the system may still suggest an equivalent or related application that may be a good substitute and address the intent of the user. For example, if the user is viewing emails with an email client, but that client is not available in the target persona, the system may suggest that another email client be launched, if such a client exists there. Such suggestions may appear even if the original application does exist in the target persona.

### Multi-Persona in Lock Mode

A device screen lock is the screen presented when the device is turned on, keeping the screen locked until some predefined explicit gesture is applied by the user. It is typically used to protect against unintentional interaction, and the user's explicit gesture unlocks the device and enables interaction. A device password lock is the screen presented when the device requires user authentication. It is used to protect against unauthorized interaction, and entry of the correct password/PIN unlocks the device and allows interaction.

Preferably, the systems and methodologies disclosed herein, allow users to switch between personas when the device is in lock-mode, without requiring the user to first unlock the screen. In some embodiments of these systems and methodologies, swiping from a predefined location on the screen to a different location indicated by some visual indicator (such as, for example, a persona icon) will implement a switch to the persona corresponding to the persona icon. Preferably, and particularly in the screen-lock mode, the newly active persona may show in its unlocked mode.

### Persona Screen Sharing and Multi-Active Personas

In some embodiments of the systems and methodologies described herein, more than one persona may be displayed concurrently on a single screen display, and the displayed personas may be concurrently active. This approach may be desirable when, for example, a user wishes to view or interact with more than a single context at one time, or when the user wishes to transfer data objects between personas. This approach is most suitable for mobile technology platforms that are equipped with larger displays, such as tablet devices, since such mobile technology platforms allow for a reasonable size display for each persona without compromising the user experience.

In the foregoing approach, it may be possible for two personas to be active at the same time. Thus, for example, the user may be able to watch a video clip in one persona, while composing an email in another. However, in some embodiments, it is also possible that only one persona may be active, while the other is static.

Moreover, each persona may be adapted to handle its own multi-touch detection mechanism. Consequently, it is possible to perform different finger gestures concurrently if each gesture is performed in the display area of the screen that is occupied by that persona. For example, if one persona has a contacts application running in its foreground and another persona has a photo displayed in the foreground, it may be possible in some embodiments to swipe down the contact list in one persona while swiping between photos (sideways) in the other persona. In a conventional, non-multi-persona system, this set of gestures may be interpreted as a pinch-to-zoom gesture, since it involves 2 fingers swiping away from each other in different directions. However, in a multi-persona system environment of the type described above, this set of gestures may instead be interpreted as different gestures occurring in different personas.

Preferably, and more generally, each persona may handle its own input modes for all input methods. Such input methods may include multi-touch input methods, as well as voice input, device movement gestures (e.g., shaking the device), and radio. In particular, it is possible to define, for each input method, distinct “prefixes” which are suitable for that input method, and to associate each “prefix” with a different persona. Consequently, when that “prefix” appears in input through that method, it telegraphs that the subsequent input is intended for the corresponding persona.

By way of specific example, a prefix of “priv” to a voice command may mean that the following command is intended for the personal persona. Likewise, a prefix which includes marking a circle at some location onscreen may mean that the following input is intended for the business persona (regardless of where it will occur on the touch screen).

As another specific example, in some embodiments of the systems and methodologies described herein, it may be possible to run different instances of a game in each persona concurrently and play with each separately. In some embodiments, the two game instances may be adapted to collaborate (inter-persona), thus allowing, for example, two players to play against each other, with each player in a distinct persona.

In some embodiments of the systems and methodologies described herein, it may also be possible to conduct interactions across personas. This may, for example, allow a user to drag a file from a persona on the right to a persona on the left. Here, it is to be noted that this is unlike dragging an object between two windows (e.g., on a desktop). This is because personas are preferably not windows and preferably do not share data or memory, and hence, an operation of this type would typically require an inter-persona communication layer.

### Persona-in-Persona (Embedded)

In some embodiments of the systems and methodologies described herein, more than one persona may be displayed concurrently, and each displayed persona may occupy a portion of the device screen. In such embodiments, a first persona may occupy the entire main screen display, and a second persona may be embedded in the first persona. The second persona may occupy a portion of the display which is overlaid on top of the first persona display. The persona icon of the embedded persona (and, optionally, any pending notification icons of the embedded persona) may be disposed or displayed in the vicinity of the overlaid screen display.

Various methodologies may be utilized to enter the foregoing type of embedded modes. For example, one such method may involve a suitable gesture on the to-(be-embedded) background persona tab area such as, for example, a long-press followed by dragging the persona tab to the main screen display. Such gestures may overlay a downscaled display of the background persona on top the active persona display. The active persona may continue to occupy the entire screen display, except for the portion of the downsized overlaid persona display. Additionally, the downsized overlaid persona display may be moved and re-located in other portions of the screen display through the use of a suitable gesture such as, for example, a finger gesture which consists of a long press following by dragging the persona screen area.

Various means may be utilized to exit an embedded mode in some of the embodiments of the systems and methodologies described herein. For example, a suitable gesture may be used for this purpose, such as dragging the persona overlay and dropping it back on the status bar area. Such gestures may also cause the dragged (formerly embedded) persona to become the active persona (in non-embedded mode). In this approach, a variety of additional functionalities may be utilized to control the state of embedding a persona in another persona. Some of these additional functionalities are described in the following exemplary embodiments.

In one such embodiment, it may be possible to switch the roles between the embedding persona and the overlaid (embedded persona) with a single gesture. This approach may be especially useful for users who wish to change their focus quickly.

In another embodiment, it may be possible to resize the portion of the embedded persona display using a suitable gesture (such as, for example, a multi-touch pinch) or in response to an event that occurs in the overlaid persona. For example if the embedded persona is playing a movie clip, the clip may be downsized to occupy a smaller portion of the screen display if the movie clip ends, or if the user does not interact with the embedded persona after a certain amount of time.

In a further embodiment, it may be possible to leave the embedded display mode and return to a one-persona display mode through the use of a suitable gesture.

One variant of this gesture may default to the embedding persona (and thus not require a persona switch). Another variant may default to the embedded persona, thus, producing a switch to the persona that was overlaid in place of the original one.

### Side-By-Side Personas (Partitioning)

In some embodiments of the systems and methodologies described herein, more than one persona may be displayed concurrently, with each persona display occupying a portion of the device screen in a side-by-side manner. Various items may be disposed in the vicinity of each persona display, including a persona indicator (e.g., an icon), a navigation tool bar (such as the home, back, and recent activities/applications), and optionally, the pending notifications icons of each persona, respectively.

The partitioning mode may be entered in various ways. For example, the partitioning mode may be entered through the use of a suitable finger gesture in the status bar area. Such a gesture may be, for example, a pinching gesture where one finger is located on one persona tab and another finger is located on another persona tab, or a pinch to zoom gesture on side-by-side personas. Such gestures will preferably resize the active persona and place the other persona on a portion of the display.

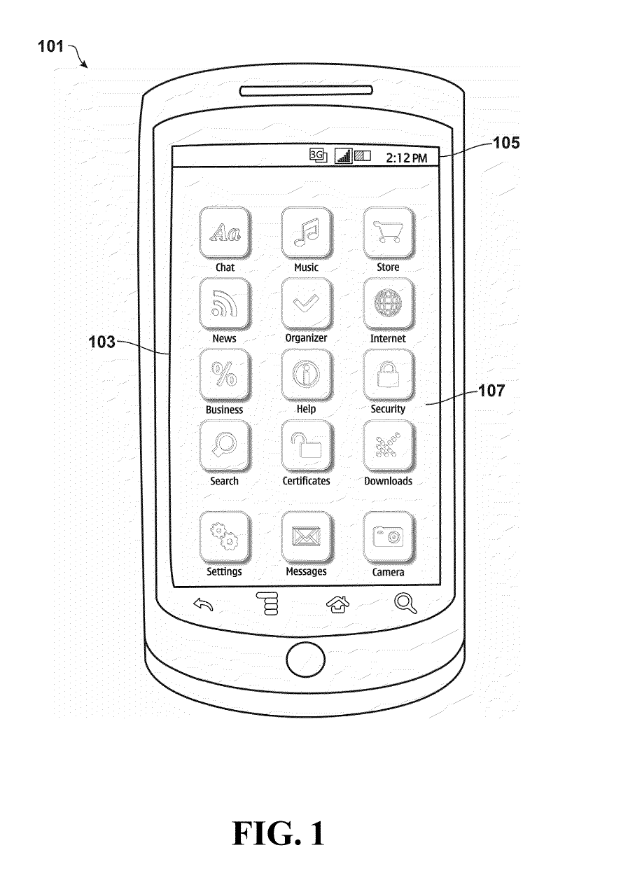

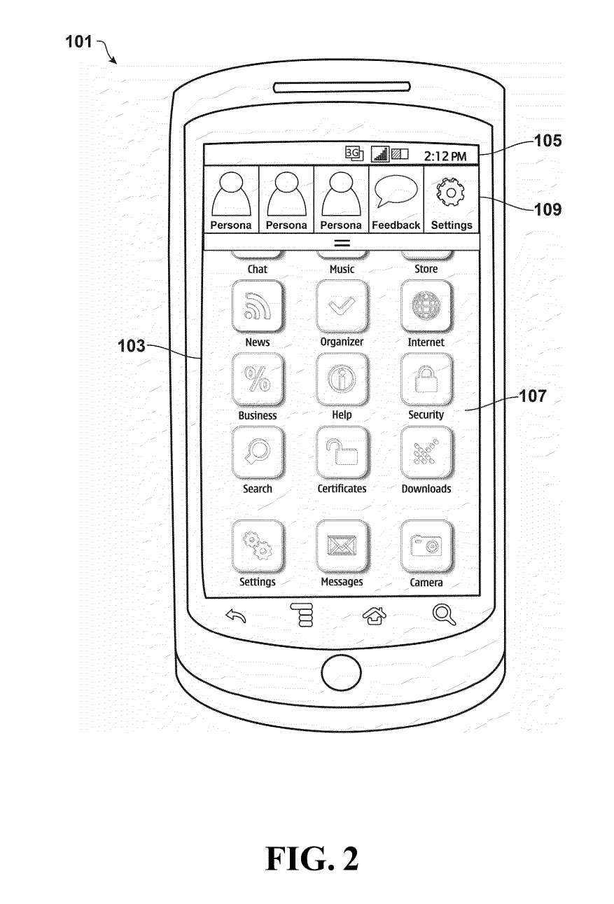

The systems and methodologies disclosed herein may further be understood in reference to the embodiments illustrated in the drawings. FIGS. 1-2 illustrate a first particular, non-limiting embodiment of a system in accordance with the teachings herein as illustrated by its renderings on a display 103 of a mobile technology platform 101. The embodiment depicted is a multi-persona operating system which utilizes color schemes to promote persona awareness. In particular, the operating system in the embodiment depicted has a status bar 105 associated with it which is rendered at the top of the display 103 of the mobile technology platform 101. The system in this particular embodiment utilizes a different background color for the status bar 105 for each persona defined on the system, so that the users will always be aware of which persona they are operating under at any point in time. In some implementations of this embodiment, the background color of the desktop 107 may be matched to the background color for the status bar 105 to further promote persona awareness. Switching between the personas is accomplished by means of a persona toolbar 109, which may be located in the notification drawer of the operating system or hypervisor.

Several variations are possible with respect to the embodiment depicted in FIGS. 1-2. For example, some variations of this embodiment may utilize patterned or gradient status bar backgrounds. Other embodiments may utilize background images, watermarks, and icon characteristics (for example, the width and color of the border of the icon, or the intensity, brightness, opacity or size of the icon) to allow the status bars of the different personas to be distinguished from each other. Still other embodiments may utilize background motions, such as undulations, starbursts, pulsations, vibrations, rotations or movements of patterns across a field to distinguish between personas. Thus, for example, in some embodiments, the background of one persona (e.g., a business persona) may be stationary, while another persona (e.g., a personal persona) may have a background that slowly undulates.

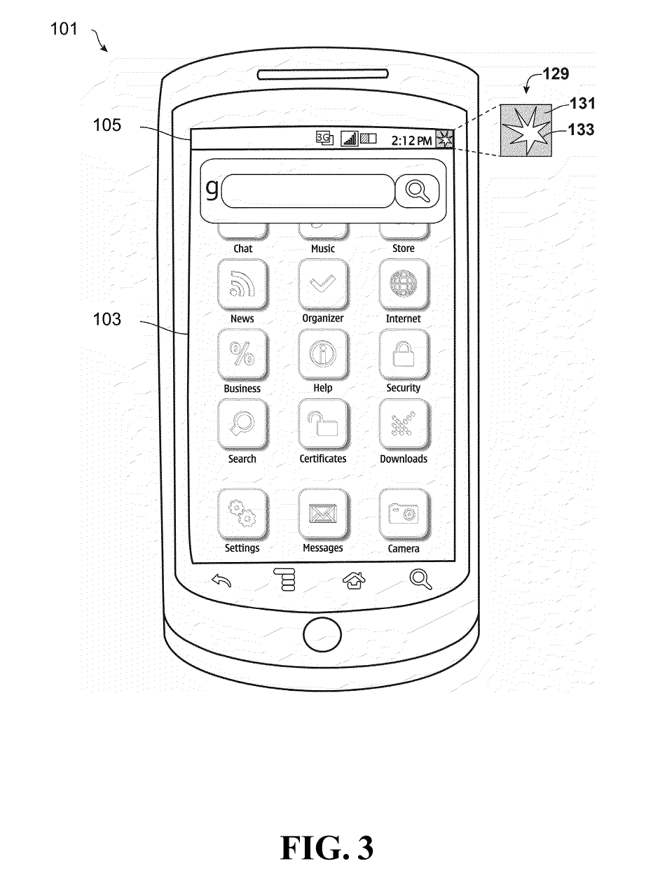

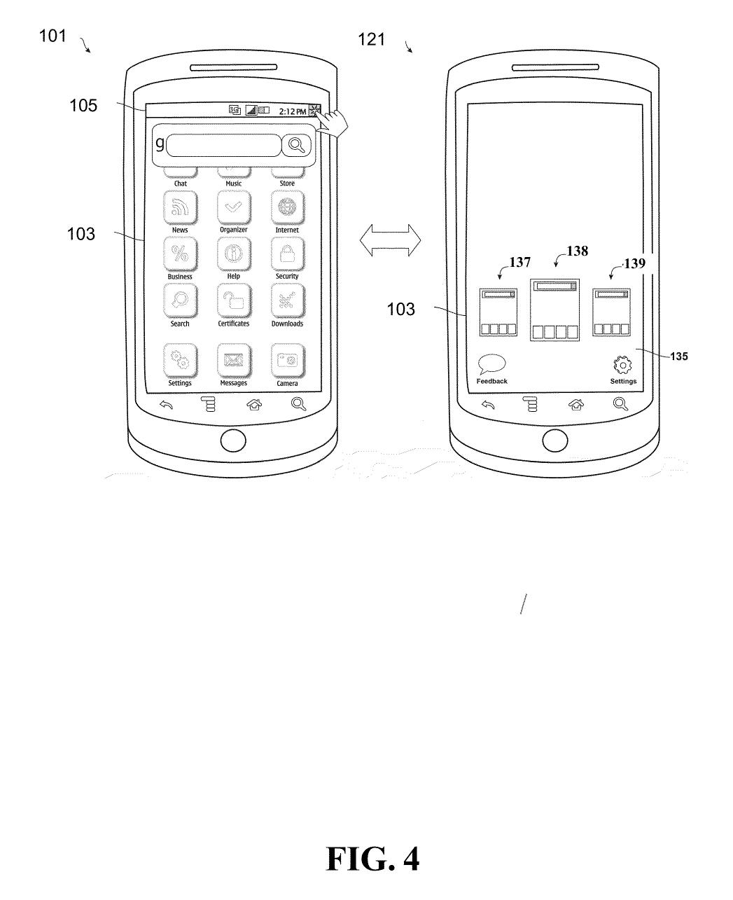

FIGS. 3-4 illustrate a second particular, non-limiting embodiment of a system in accordance with the teachings herein as illustrated by its renderings on a display, such as display 103 of a mobile technology platform 101. In the embodiment depicted, each persona has a tab 129 associated with it which is disposed in the status bar (e.g., status bar 105). The tab 129 consists of a background 131 (characterized by a background color) and an icon 133. The tab 129 corresponding to the active persona is positioned in the rightmost portion of the status bar 105.

In the embodiment depicted, the color of the background 131 and icon 133 are utilized to signify the foreground persona. The icon 133 may be selected by the user or by an administrator, or it may be dictated by system defaults. The icon 133 preferably signifies the objective of the persona. Thus, for example, a corporate icon may be utilized to signify the corporate persona. The corporate icon may be generic, or may be customizable to include, for example, a corporate logo. Similarly, a personal icon may be utilized to signify a personal persona, which may also be generic or customizable.

The color of the background 131 may serve both as a persona differentiator and as a highlighter of the icon 133 to allow it to stand out from the rest of status bar icons, as this is an environment of its own. In the ANDROID® operating system, the right-hand portion of the status bar 105 is used to indicate the status of the phone features, while the left-hand portion of the status bar 105 is used to provide phone notifications. It will thus be appreciated that, in such an environment, a disposition of the tab 129 on the right portion of the status bar 105 may be the most suitable.

As seen in FIG. 4, in some implementations of this embodiment, selecting the tab 129 launches a persona switch screen 135, which includes a graphical depiction of the available personas 137 and allows the user to select the active persona from among them. Preferably, as seen in FIG. 4, the currently active persona 138 is centered on the persona switch screen 135 and is larger in size than the inactive personas 139.

In embodiments where the persona icon is handled as a button, the icon 133 may be utilized as a means to toggle between personas (especially in cases where only two personas are defined), or its selection may spawn a persona switch screen from which the user may select a persona to switch to. Background persona notifications may be implemented in this embodiment by causing the color of the background 131 of the tab 129 to pulsate.

In some implementations, the foregoing embodiment is particularly desirable in that icons are often easier for the user to learn than colors, and there is no risk of icons clashing with the background color. On the other hand, in some implementations, it may not be possible to display notifications, and the icons may be too small for touch events.

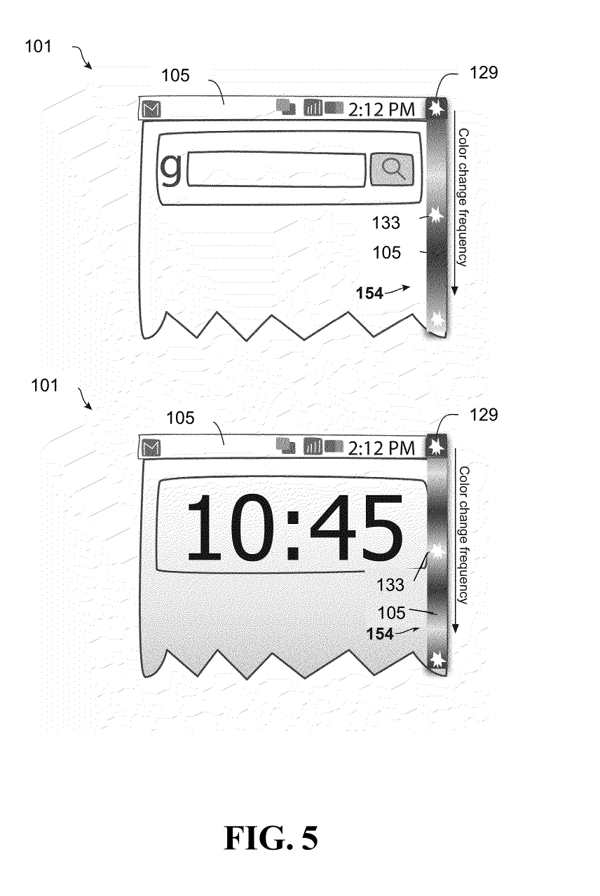

FIG. 5 illustrates another particular, non-limiting embodiment of a system in accordance with the teachings herein as illustrated by its renderings on the display of a mobile technology platform (e.g., mobile technology platform 101). For simplicity of illustration, only the upper portion of the mobile technology platform 101 is shown. The embodiment depicted is similar in many respects to the embodiment of FIGS. 3-4. However, this embodiment utilizes a particular, non-limiting embodiment of a method which may be employed in the systems described herein to inform the user that a notification has been received in a background persona.

In the embodiment depicted, each persona again has a tab (e.g., tab 129) associated with it which is disposed in the status bar (e.g., status bar 105). As in the embodiment of FIGS. 3-4, the tab 129 consists of a background, such as, background 105 (characterized by a background color) and an icon, such as, icon 133. The tab 129 corresponding to the active persona is positioned in the rightmost portion of the status bar 105. As in some of the previously described embodiments, the color of the background 131 and icon 133 may be utilized to signify the foreground persona.

When an unread notification underlies the background persona, a slow ‘breathing’ effect (moderated blinking) takes place in the color of the background 101 of the persona icon 133. The color change in the background 101, and the frequency of that color change, is depicted in the vertical overlay 154 shown in FIG. 5.

Preferably, if the mobile technology platform is in phone lock mode, a faster breathing effect will take place, to address the case where a user just wants to briefly check missed notifications while he was away. Of course, it will be appreciated that various other means may be utilized in the systems and methodologies described herein to notify a user that a notification has been received including, without limitation, changes in size in the persona icon.

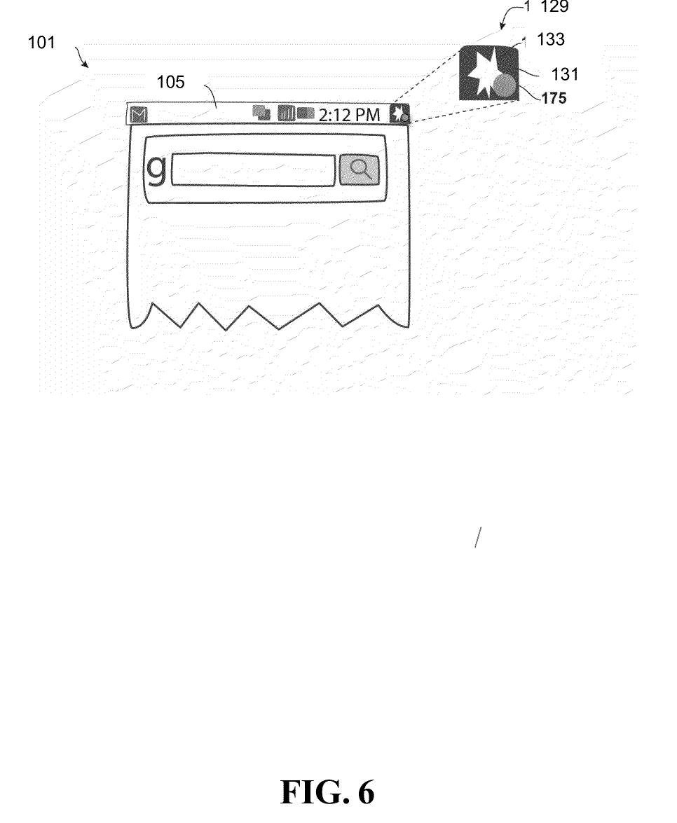

FIG. 6 illustrates a further particular, non-limiting embodiment of a system and associated methodology in accordance with the teachings herein, as illustrated by its renderings on the display of a mobile technology platform (e.g., mobile technology platform 101). For simplicity of illustration, only the upper portion of the mobile technology platform 101) is shown.

In the embodiment depicted, as in the embodiment of FIG. 5, each persona again has a tab 129 associated with it which is disposed in the status bar (status bar 105), and each tab 129 consists of a background, such as, background 131 (characterized by a background color) and an icon, such as, icon 133. The tab 129 corresponding to the active persona is positioned in the rightmost portion of the status bar 105. However, unlike the embodiment of FIG. 5, in the embodiment of FIG. 6, a static color indicator 175 is used to signify unread notifications in the background persona.

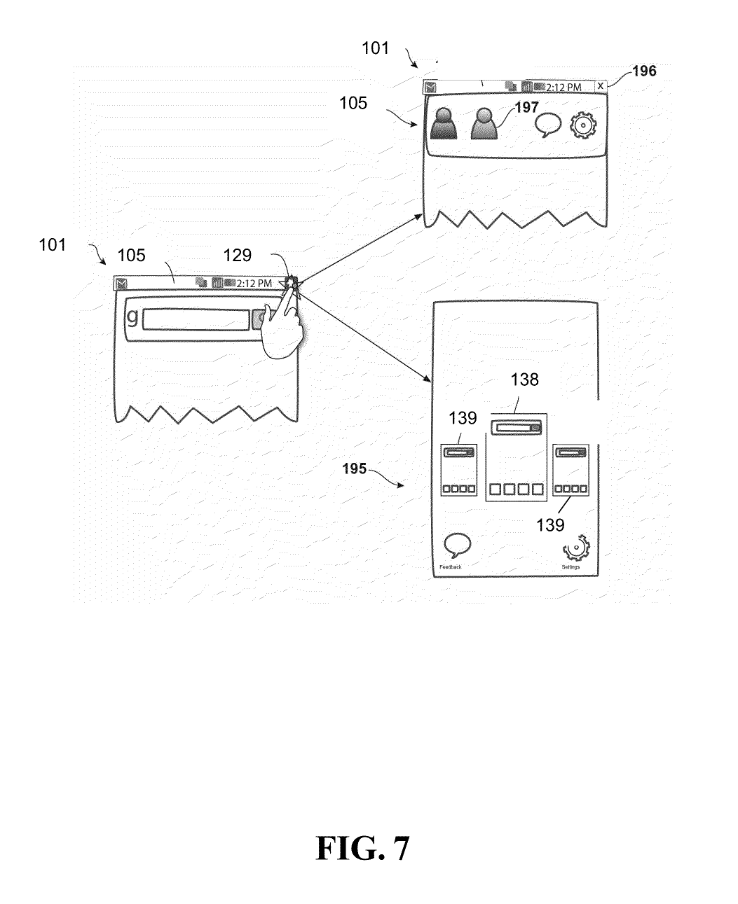

FIG. 7 depicts a further particular, non-limiting embodiment of a system and associated methodology in accordance with the teachings herein, as illustrated by its renderings on the display of a mobile technology platform 101. For simplicity of illustration, only the upper portion of the mobile technology platform 101 is shown.

The embodiment depicted is similar in most respects to the embodiment of FIG. 5. However, one or both of two options may be utilized to allow the user to switch personas in the icon-based status bar (e.g., status bar 105).

In the first option, a pop-up toolbar 195 is accessible under the status bar 105 by clicking on a tab (e.g., tab 129) associated with the active persona. The pop-up toolbar 195 is similar in some respects to the notification drawer described above, but pops up only when the tab 129 associated with the active persona is selected. The pop-up toolbar 195 displays, among other things, selectable icons (such as, icon 133, FIG. 6) which can be used to switch to each persona. These icons 133 are preferably color-coded to correspond in color to the tab 129 associated with each persona. When the pop-up toolbar 195 is displayed, the tab 129 turns to an ‘x’ 196 (or assumes another appropriate form or visual indicator) to signify the closure of the status bar 105, and also to de-signify the persona state while the pop-up toolbar 195 is open.

In the second option, full window application or activity is provided. In this option, thumbnail images of the active persona (e.g., persona 138) and inactive persona (e.g., persona 139) are displayed.

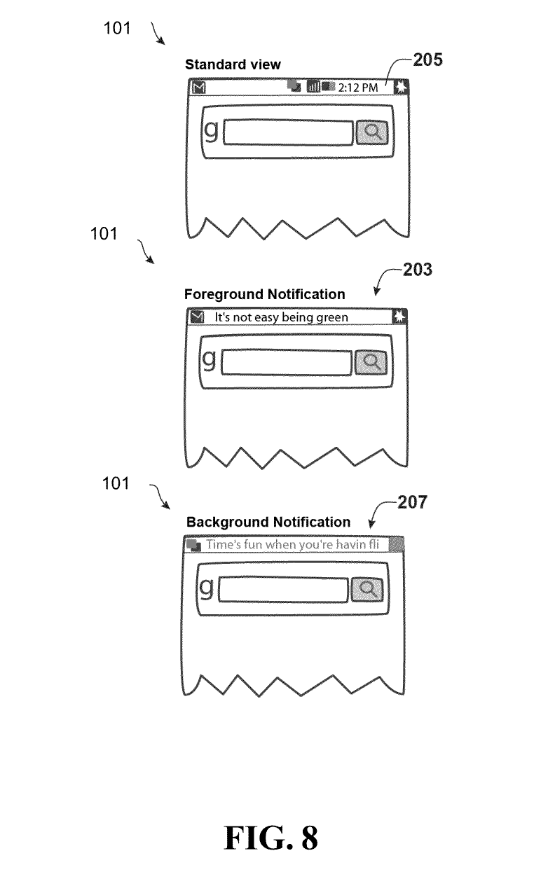

FIG. 8 illustrates a further particular, non-limiting embodiment of a system and methodology in accordance with the teachings herein as illustrated by its renderings on the display of a mobile technology platform (e.g., mobile technology platform 101). The particular embodiment depicted utilizes an icon-based system for providing notification of incoming messages. Thus, when a foreground notification 203 is present, it is displayed as a normal notification message on the toolbar 205. When a background notification 207 is present, the persona icon will be hidden, its background color will change to a neutral color such as gray, and the message text of the background notification 207 will be displayed in the color of the corresponding persona.

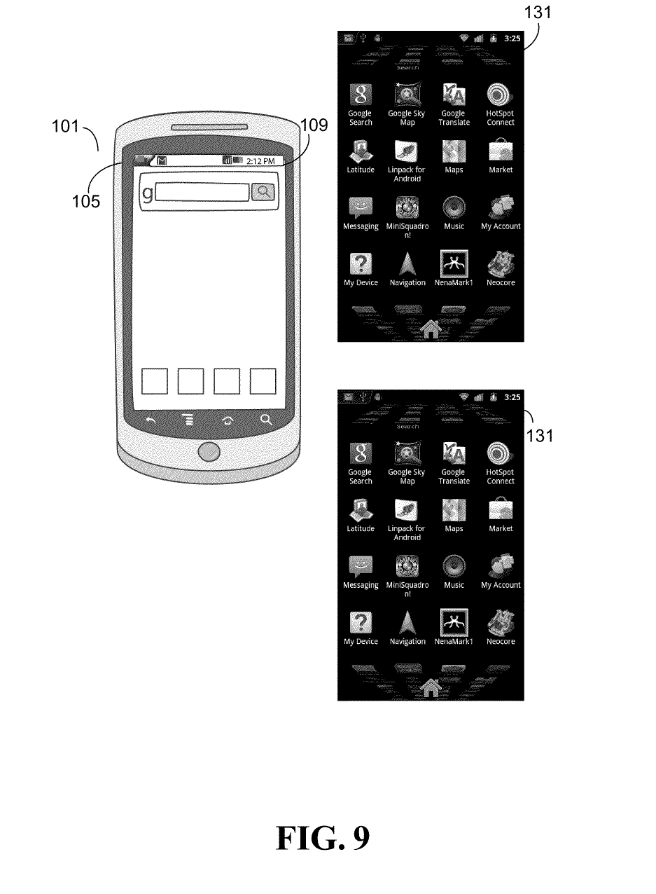

FIG. 9 illustrates a further particular, non-limiting embodiment of a system and methodology in accordance with the teachings herein as illustrated by its renderings on the display of a mobile technology platform 101. The particular embodiment depicted employs status bars (e.g., status bar 105) equipped with tabs (e.g., tab 129). The use of tabs allows the user to view notifications from two personas simultaneously, in the foreground and background. Initially, the status bar 105 corresponding to the foreground persona spans the entire status area. However, when a notification spawns in the background persona, the tab layout shows and ‘reveals’ the background notification area 131.

Personas in this embodiment may be distinguished by their background status color, as in some of the embodiments described above. The use of tabs also adds visualization to personas, since it allows the background persona to actually appear as if it is in the background. This visualization aid may help to build a solid mental model for users.

The approach implemented in the embodiment of FIG. 9 does not assume equality amongst personas. Instead, it may be that a user has a main persona which the user prefers to work on (or works on predominantly), and makes an occasional switch to another persona when triggered to do so or when the user wishes to check on the status of, or notifications pending for, another persona. In some embodiments, a prolonged tap may be utilized to switch to the same application, or to a similar application, in another persona.

In the embodiment of FIG. 9, it is preferred that, as more notifications come in from the background persona, more of these notifications are revealed in the background. New rules for managing the notification system in implementations of this embodiment may be necessary or desirable as the background notifications consume increasing portions of the notification status real estate. Preferably, selection of the background status bar toggles between personas, although switching between personas may also be accomplished by other suitable means. Such other suitable means may include, for example, through suitable gestures, or via non-display methods, such as double clicking on a home button, through a combination of hardware buttons, or via an input from a sensor.

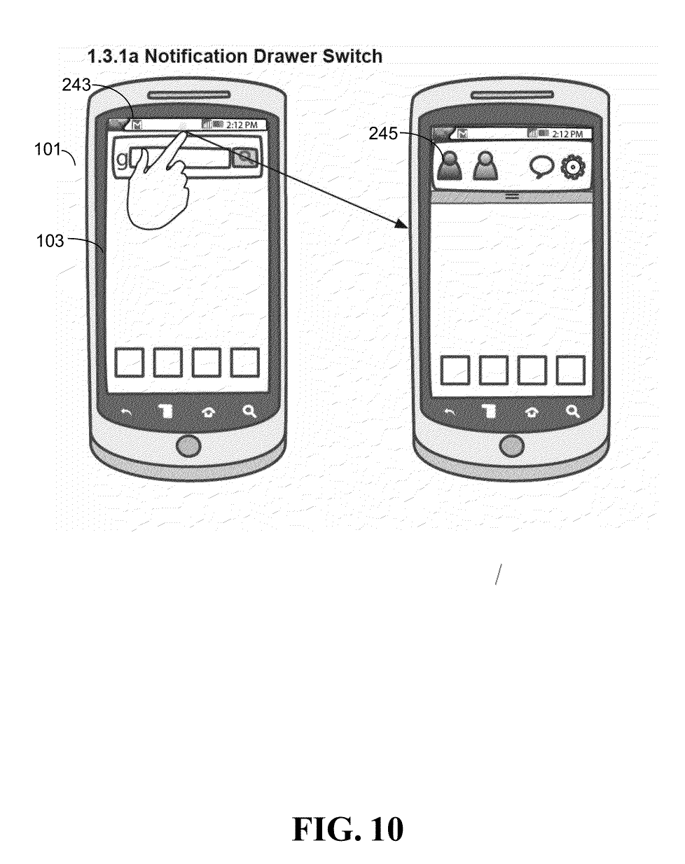

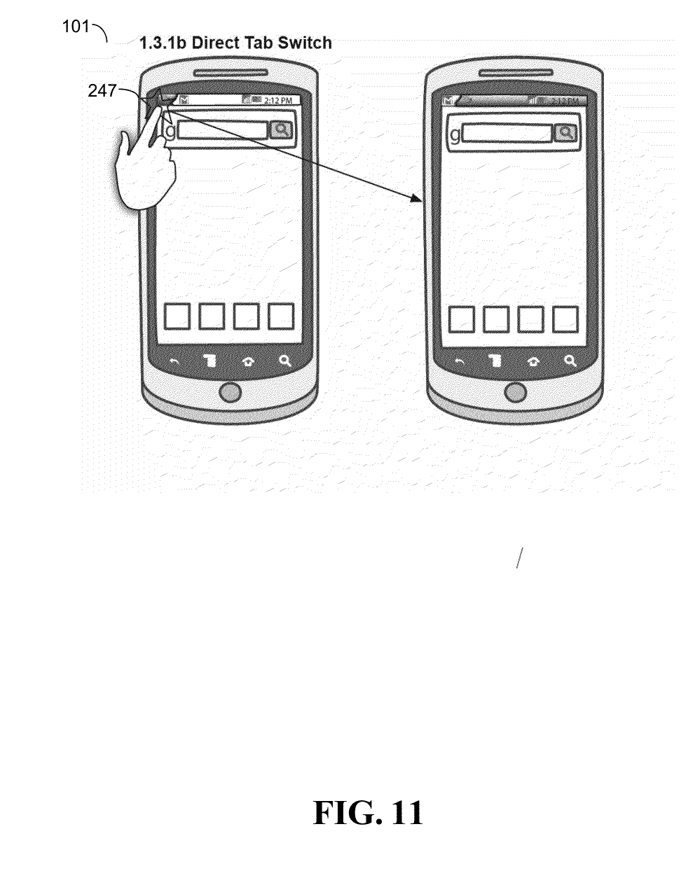

FIGS. 10-11 illustrate a further particular, non-limiting embodiment of a system in accordance with the teachings herein as illustrated by its renderings on the display, such as, display 103 of a mobile 101. In this embodiment, two options are considered to allow the user to toggle between personas in the tabbed status bar 243. In the first option, which is depicted in FIG. 10, pulling down the status bar 243 reveals the persona switch control panel 245 in the notification drawer of the operating system.

In the second option, which is depicted in FIG. 11, selecting any of the background personas 247 reveals the status bar area 249, which will switch it to the foreground with a suitable animation. Preferably, these two options co-exist.

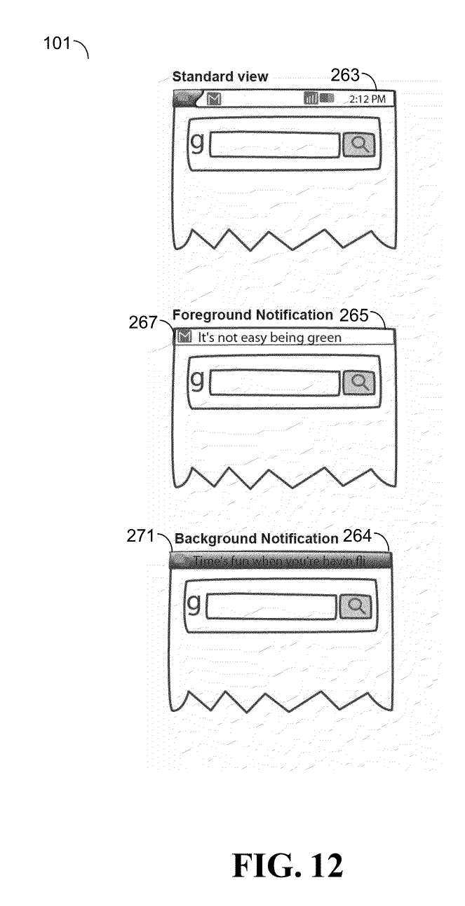

FIG. 12 illustrates a further particular, non-limiting embodiment of a system in accordance with the teachings herein as illustrated by its renderings on the display of a mobile technology platform (e.g., mobile technology platform 101). For ease of illustration, only the upper portion of the mobile technology platform 101 is shown. This embodiment utilizes a tabbed status bar 263 as part of an incoming notification scheme. As seen therein, when a foreground notification is incoming, the foreground status bar tab 265 slides up, followed by the notification message 267. The foreground status bar tab 265 then slides back down after message 267 has been displayed. When a background notification is incoming, the background status bar tab 264 slides down, followed by the notification message 271. The background status bar tab 264 then slides back up after message 271 has been displayed.

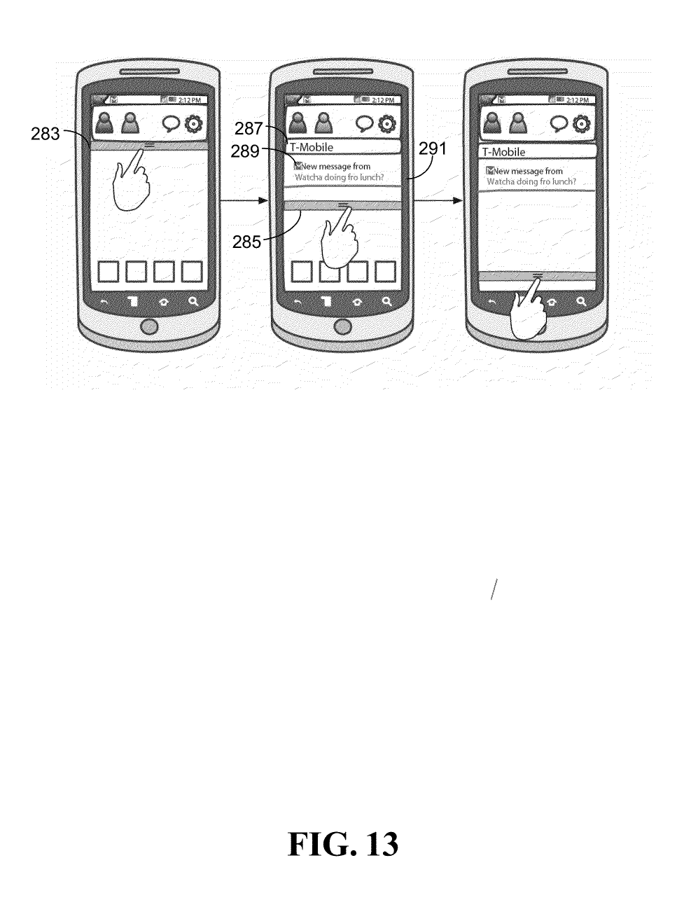

FIG. 13 illustrates a further particular, non-limiting embodiment of a system in accordance with the teachings herein as illustrated by its renderings on the display of a mobile technology platform (e.g., mobile technology platform 101). This embodiment utilizes a tabbed status bar notification drawer 283. As seen therein, when the user drags the notification drawer 283 from the top status bar 285 downward, the following elements are revealed in the following order: (1) the persona toolbar 287; (2) the notification items 289 from least recent to most recent; and (3) the clear background pane 291. In some implementations, setting these items in this order may allow the persona toolbar 287 to be much more discoverable. In particular, the persona toolbar 287 may be noticeable, and the highlighted foreground persona may be easily perceived even with a sneak peek, and without extending the notification drawer 283 to its full length.

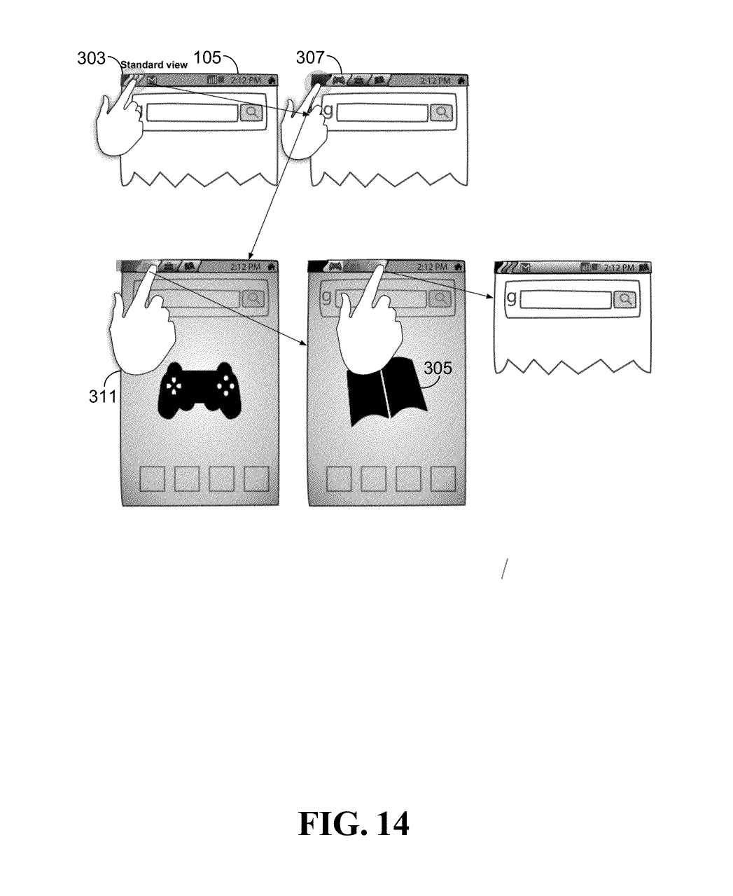

FIG. 14 illustrates a further particular, non-limiting embodiment of a system in accordance with the teachings herein as illustrated by its renderings on the display of a mobile technology platform (e.g., mobile technology platform 101). For ease of illustration, only the upper portion of the mobile technology platform 101 is shown. The particular embodiment depicted utilizes a tabbed, multiple persona scheme. As seen in FIG. 14, the left side of the status bar 303 shows a contracted view of all of the tabs 105. A suitable gesture or set of steps (such as, for example, pressing and holding the contracted view, preferably for a duration within the range of about 0.2 to about 0.3 seconds) will expand all the tabs 105 to reveal the persona icon 307 corresponding to each one. All notification icons of the active persona will clear during this mode. Swiping the finger to the right may darken and blur the active persona 311 occupying the main screen display, or may display any other visual effect to signify that the main screen display is temporarily disabled, and will display a large image icon 313 corresponding to the persona tab that the finger is on at that time (to overcome the fat finger syndrome). Releasing the finger will swap the active persona 311 to that corresponding to the last tab 305 that the finger was on.

Several variations are possible with respect to the foregoing embodiment. For example, instead of displaying the contracted view at the left of the status bar 303, a generic icon may be utilized instead. Also, the number of pending notifications of each persona may be displayed next to the icon corresponding to that persona. In some embodiments, the system may be adapted such that tapping or selecting that area may open a control bar, in a manner similar to the icon paradigm. Also, additional information may be displayed in that persona icon overlay such as, for example, the latest notifications. Finally, the height of the status bar 303 may be expanded by pressing and holding the status bar 303, thus gaining more hit area per tab 105 and permitting additional information to be displayed.

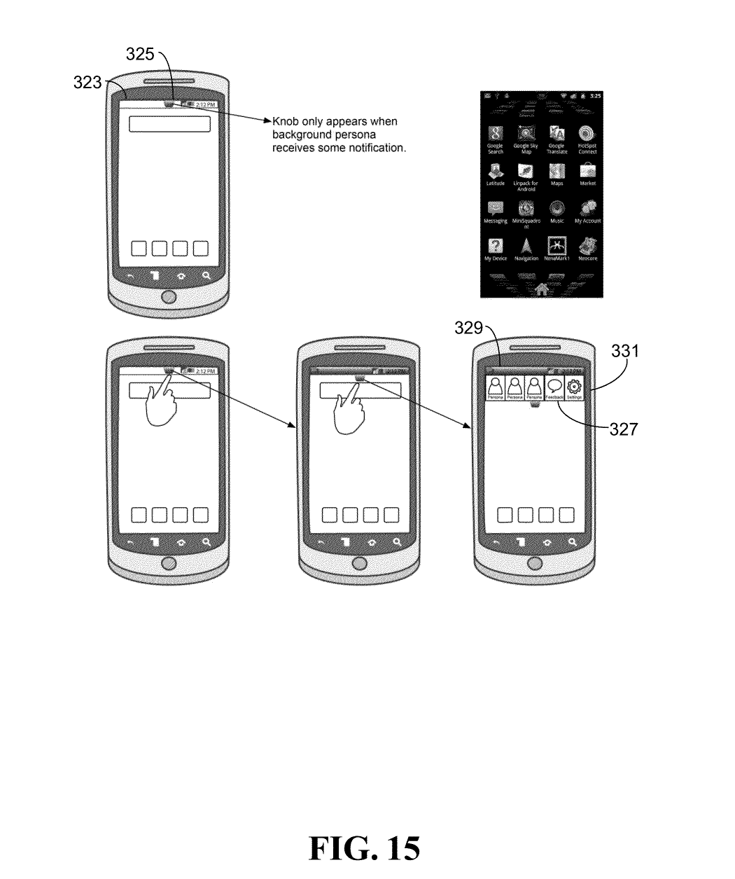

FIG. 15 illustrates a further particular, non-limiting embodiment of a system and methodology in accordance with the teachings herein as illustrated by its renderings on the display of a mobile technology platform (e.g., mobile technology platform 101). The particular embodiment depicted utilizes a status bar 323 equipped with a knob 325. The knob 325 introduces a secondary notification drawer 327. As the knob 325 is pulled, it reveals, in succession, the status bar 329 of the background persona, the persona toolbar 331, and the notifications of the background persona. Pulling the status bar 329 outside the knob 325 reveals the notification drawer 327 of the active persona.

In the embodiment of FIG. 15, personas are preferably distinguished by their background status color, as in some of the embodiments described above, although it will be appreciated that various other suitable indicators may be utilized to distinguish personas from one another. Preferably, the knob 325 will only appear if there is some notification in the background persona, and is semi-transparent, so that background icons 335 of the status bar 329 can be seen through it.

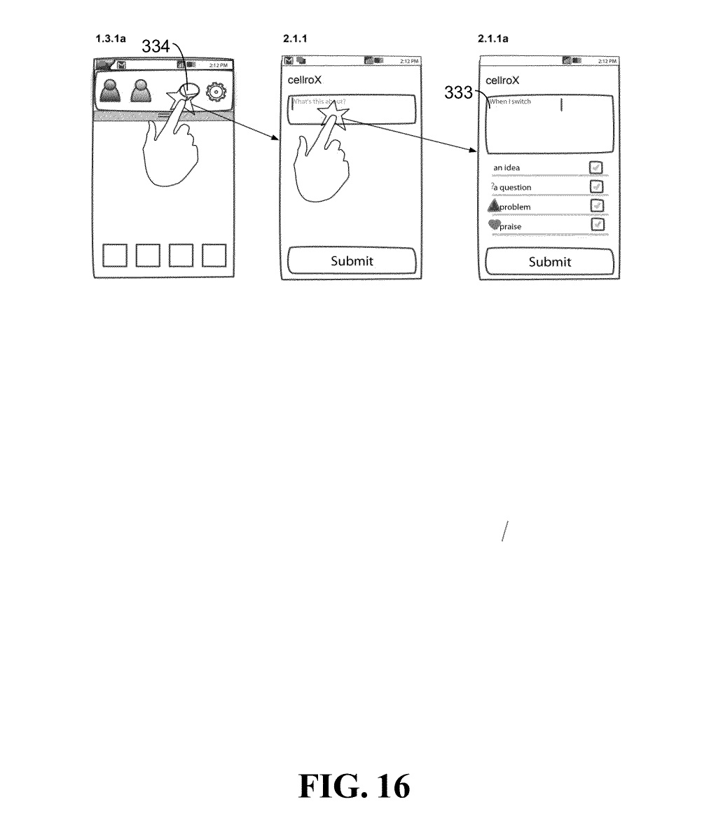

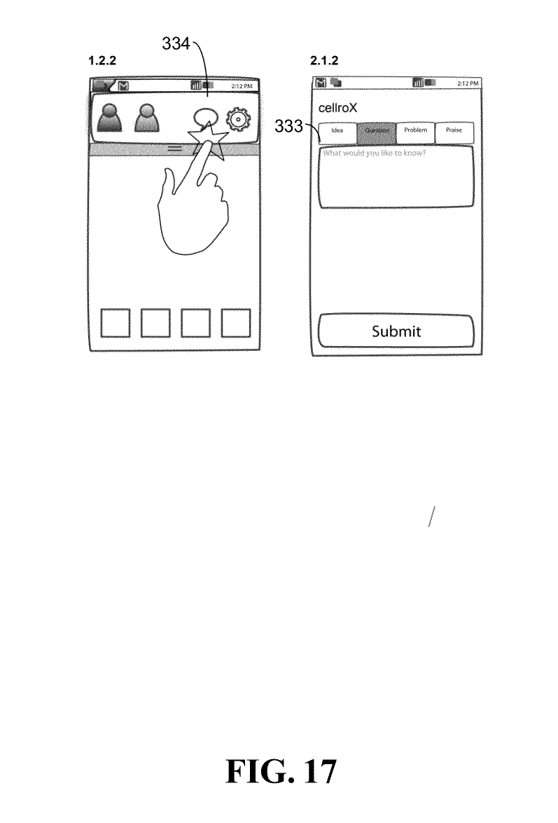

FIGS. 16-17 depict embodiments of a feedback system in accordance with the teachings herein. In the system depicted, the feedback application 333 is accessible from the notification center area 334 at any state of the device. When launched from the notification center area 334, the feedback application 333 is displayed and may be utilized by the user to input feedback on the multi-persona system. Such feedback may include, for example, bug reports, suggestions, or accolades. After the user inputs the necessary information, the feedback is then sent to a dedicated processing server, along with additional system log information, for further processing.

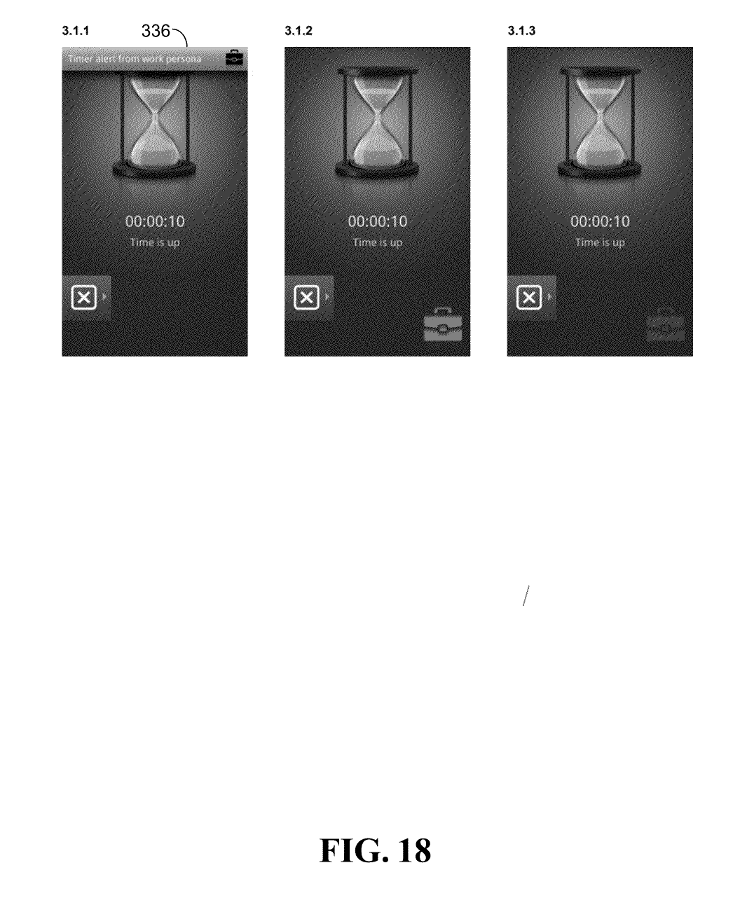

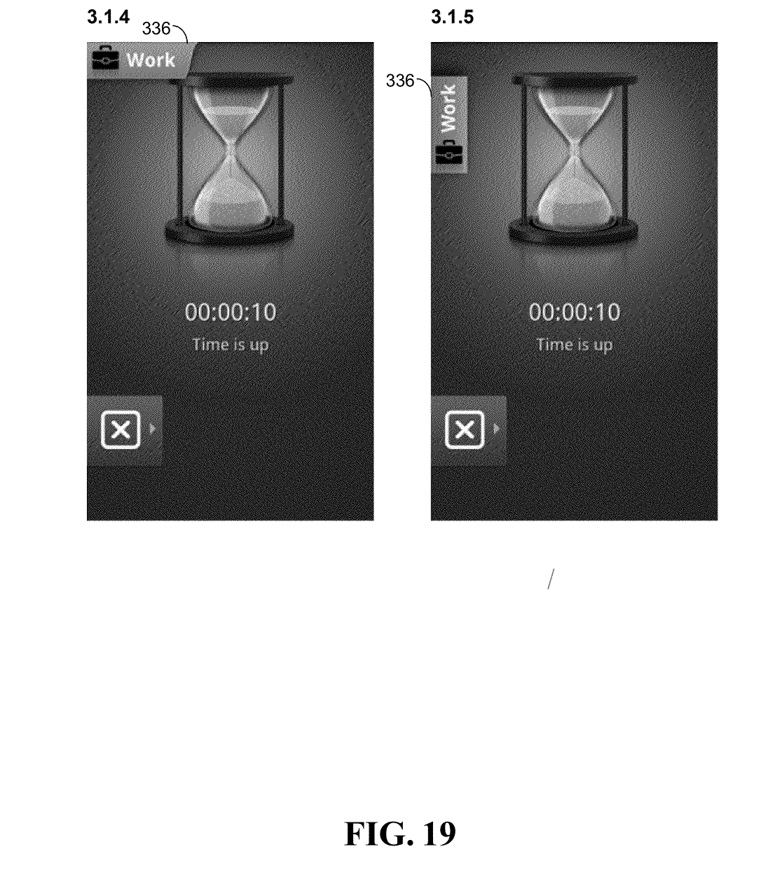

FIGS. 18-19 depict embodiments of alert systems in accordance with the teachings herein. In the embodiments depicted, when an alert occupies the entire screen area, a visual indication of the persona 336 the alert is launched from is overlaid on top of some portion of the screen area. Such alerts may include, for example, an alarm clock alert or an incoming call alert. Thus, by way of illustration, when an incoming call arrives from a contact in the business persona, the business persona icon is overlaid on top of the incoming call screen.

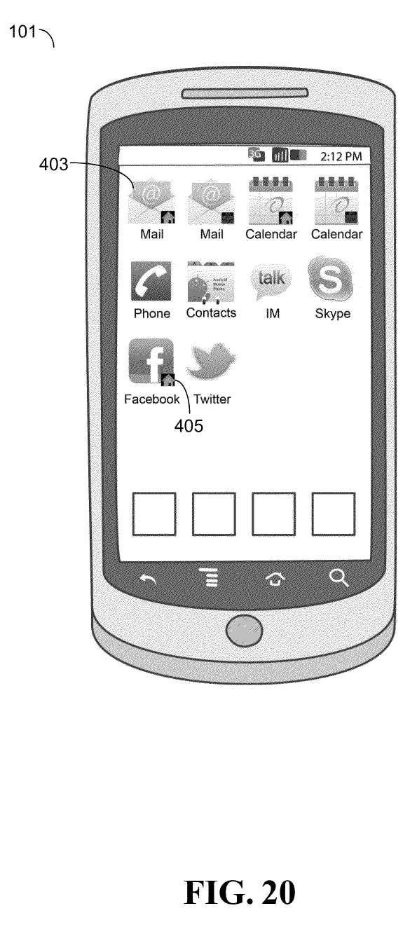

FIG. 20 depicts a first particular, non-limiting embodiment of an application distribution system in accordance with the teachings herein as illustrated by its renderings on the display of a mobile technology platform (e.g., mobile technology platform 101). The system depicted therein features a single desktop view that can feature application icons 403 that are installed on any persona. The desktop view is preferably not attached to any persona. Preferably, a visual cue 405 is provided which indicates the persona on which the application is installed. In the particular embodiment depicted, the visual cue 405 is implemented as a miniature icon, which is overlaid on the bottom right corner of the application icon 403. However, one skilled in the art will appreciate that the visual cue 405 may assume a variety of forms and may be implemented in various ways.

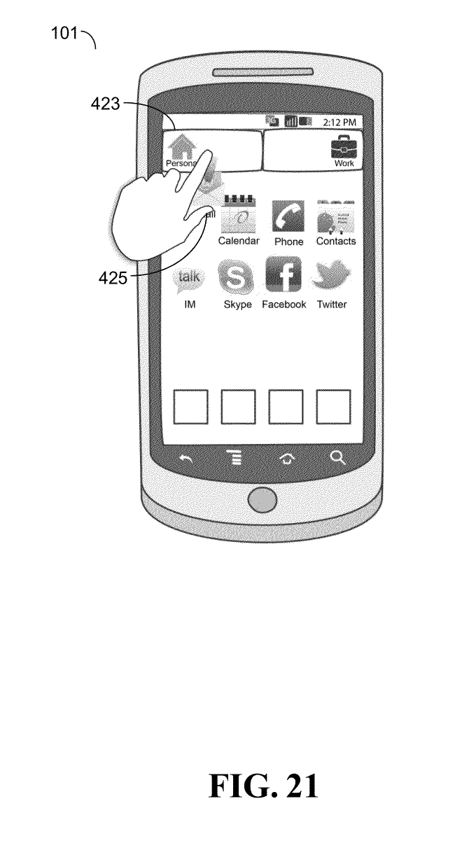

FIG. 21 depicts a second particular, non-limiting embodiment of an application distribution system in accordance with the teachings herein as illustrated by its renderings on the display of a mobile technology platform (e.g., mobile technology platform 101). The system depicted therein features a single desktop view that features persona hot areas 423. Dragging an application icon 425 to the hot area 423 (or, in some embodiments, dragging the hot area 423 onto the application icon 425) launches the corresponding application in that persona with the exclusive content associated with that persona, while clicking the application icon 425 outside of the hot area 423 will launch the application in a globally shared content. The desktop view is preferably not attached to any persona.

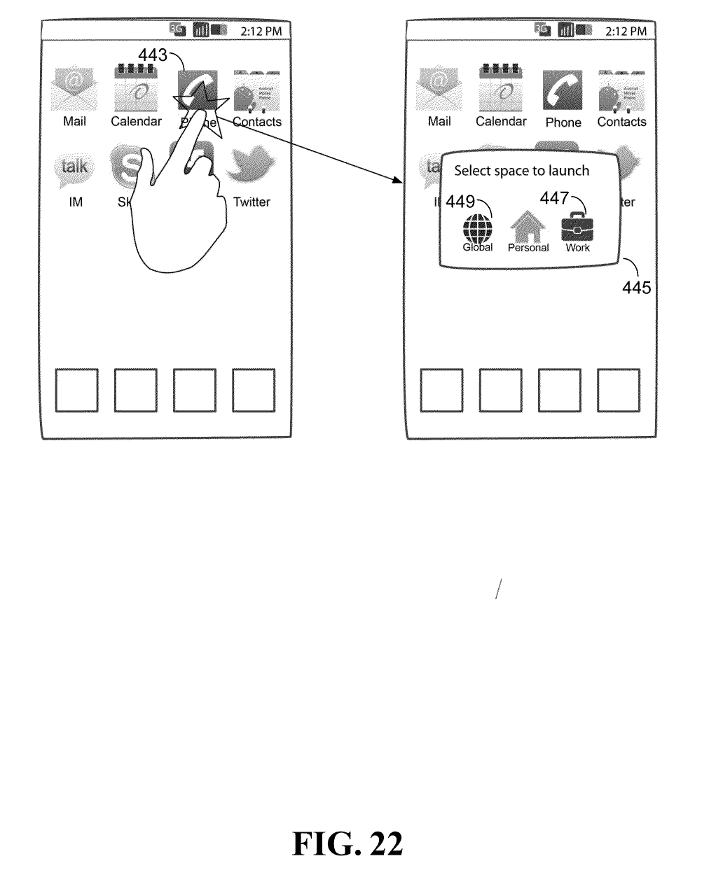

FIG. 22 depicts a third particular, non-limiting embodiment of an application distribution system in accordance with the teachings herein as illustrated by its renderings on the display of a mobile technology platform (e.g., mobile technology platform 101). The system depicted therein features a single desktop view. In the particular embodiment depicted, clicking the application icon 443 will prompt a persona selection interface 445. The user may utilize this interface 445 to select the persona 447 to launch the application (here, it is to be noted that not all applications may be available in all personas), or else the user may choose to launch the application in a global content environment. The selection items are the list of all available personas 447, as well as a global persona 449. The desktop view is preferably not attached to any particular persona.

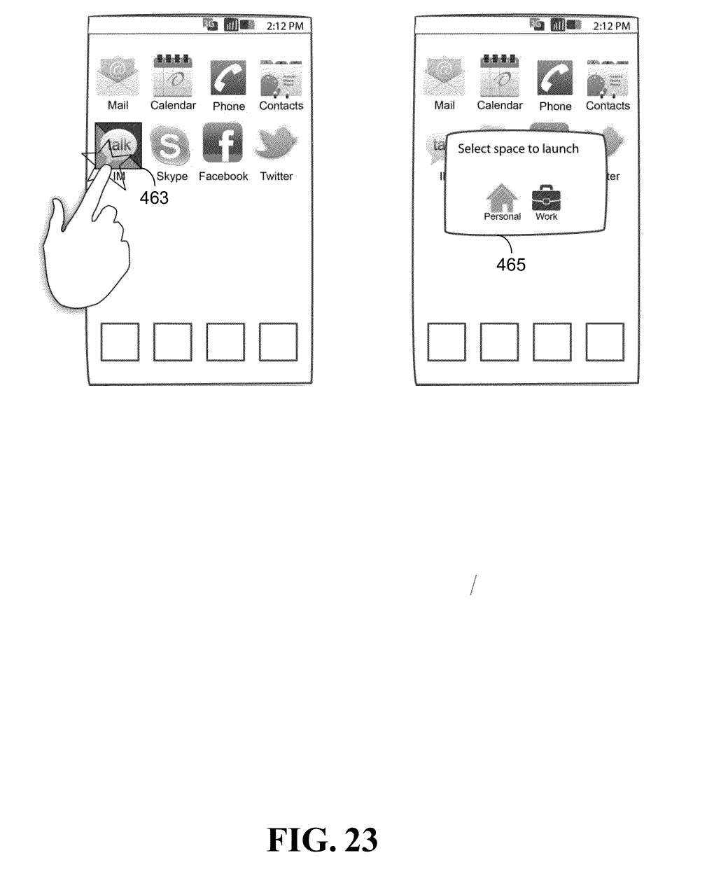

FIG. 23 depicts a fourth particular, non-limiting embodiment of an application distribution system in accordance with the teachings herein as illustrated by its renderings on the display of a mobile communications device. The particular embodiment depicted features a single desktop view. In this embodiment, selection of an application icon 463 will launch a persona selection interface 465, from which the user may choose the persona from which to launch the application (here, it is to be noted that not all applications may be available in all personas). The selection items are based on predefined application settings set by the user. The desktop view is preferably not attached to any particular persona.

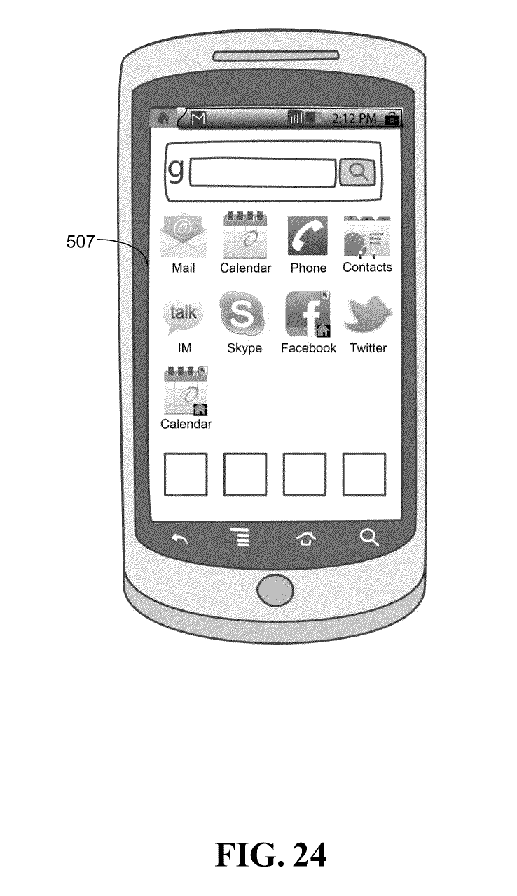

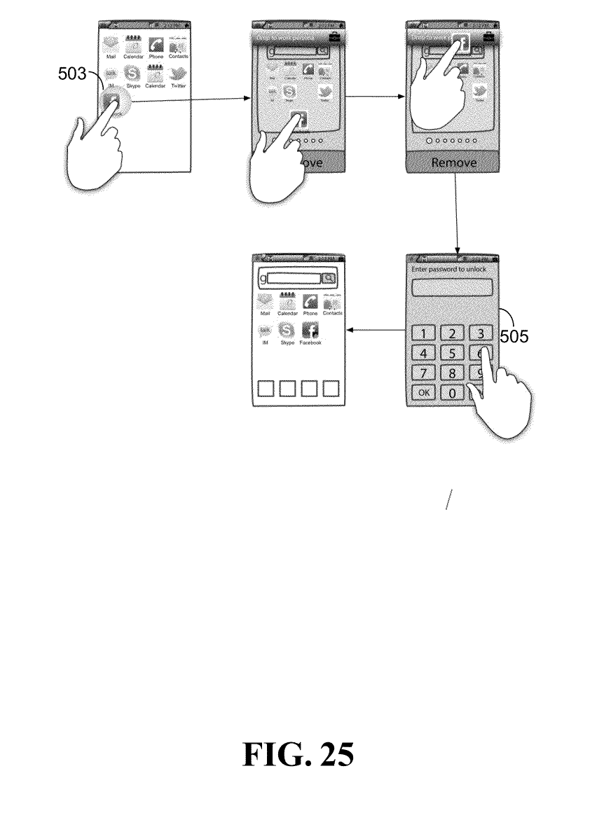

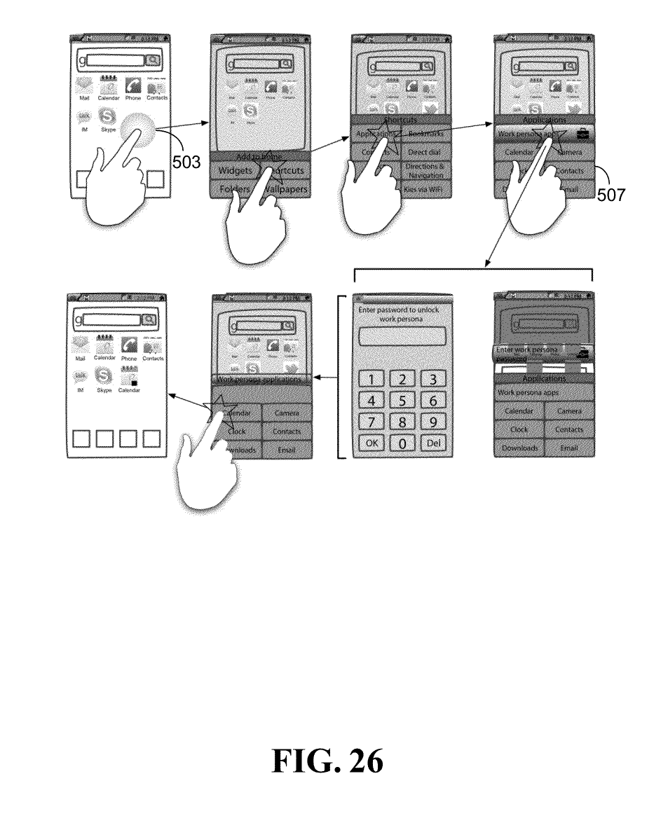

FIGS. 24-26 depict particular, non-limiting embodiments of methods for creating a reference system which may be implemented in the systems described herein. These methods are illustrated by their corresponding renderings on the display of a mobile technology. In the methods depicted, every installed application in a persona has exclusive content application references 503 to the persona, which are similar to shortcuts on a PC. These may be created by referencing applications from other personas. Consequently, application references 503 from one persona can sit in another persona for convenience. Preferably, visual cues 505 on the application references 503 are used to portray the application, its reference type and the referenced persona. It is also preferred that references can only be created on the desktop 507.

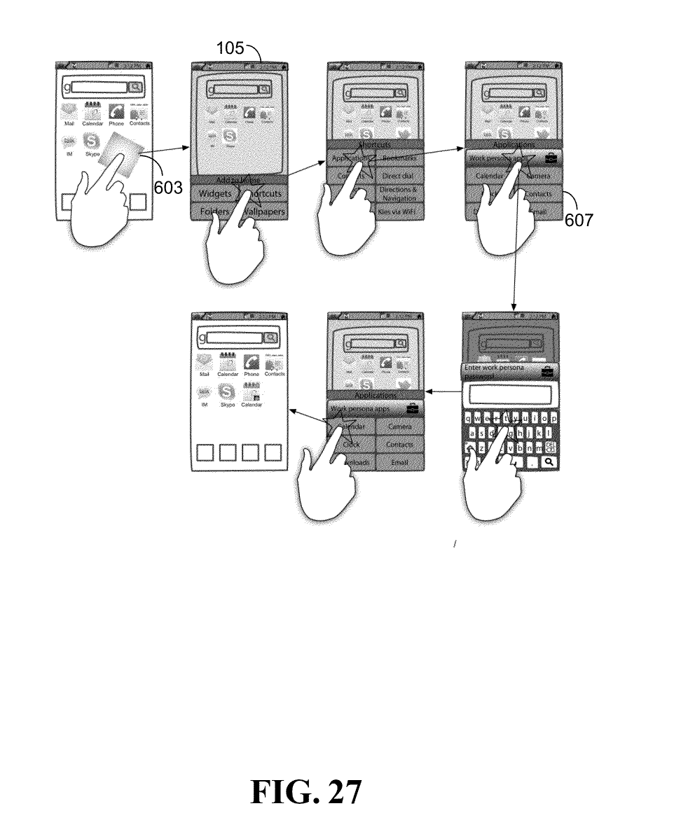

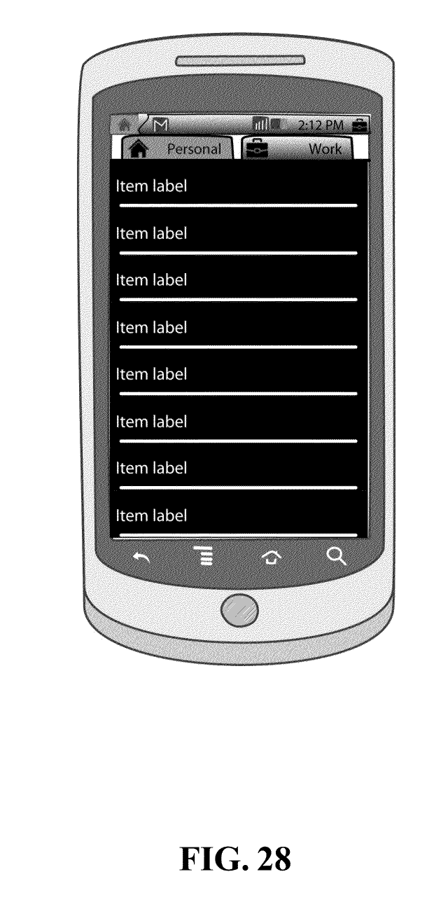

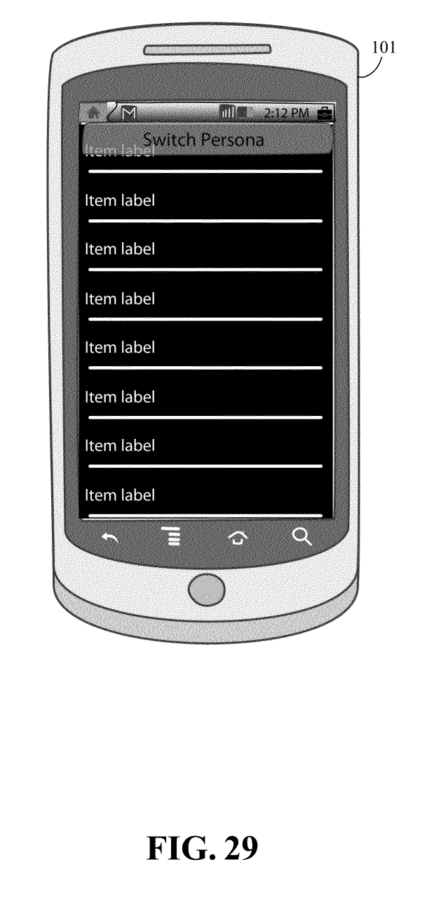

FIGS. 27-29 depict a particular, non-limiting embodiment of the in-application persona content in a system of the type disclosed herein as illustrated by its renderings on the display of a mobile technology platform (e.g., mobile technology platform 101). As seen therein, in the particular embodiment depicted, a temporary popup button 603 appears once the application loads. The tab, such as, tab 105 is disposed on top of the application layout 607, and is scrolled up to be hidden. This is similar to the address bar behavior found in the current ANDROID® browser.

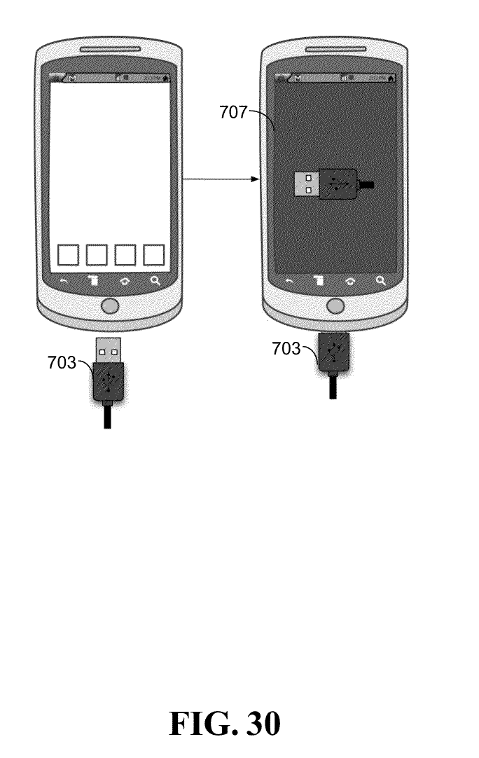

FIG. 30 illustrates a particular, non-limiting embodiment of a system for interfacing with hardware resources in accordance with the teachings herein. The system is illustrated by its renderings on the display of a mobile technology platform. In the particular embodiment depicted, when a USB cable 703 is being connected between the device and a PC, only the active persona will expose its interface 707 to the host. Preferably, there is only one persona connected to the host at any given time.

There are several assumptions that form the basis for this approach. First of all, host applications which rely on protocols such as UMS or MTP (such as, for example, DOUBLETWIST® or Samsung KIES®) might not properly support a device with two or more exposed protocols from one device, or might cause some confusion for the user which might lead to mistakes such as such as synching with the wrong persona. Also, multiple mount points on a host may cause confusion for the user regarding which mount point is matched to which persona. Dragging files from or to the wrong persona mount point may result in the frustration of not being able to find the files again in the correct persona, or may cause a possible security breach when a secure file is placed in the mount point of an unsecured persona. In addition, for security reasons, secured personas are preferably unlocked from their password protection before UMS can be mounted. Once a persona is connected to the USB host, it will persist in that connection, unless the connection is explicitly changed by the user. Preferably, switching a persona while a USB cable is connected will not switch the USB connection.

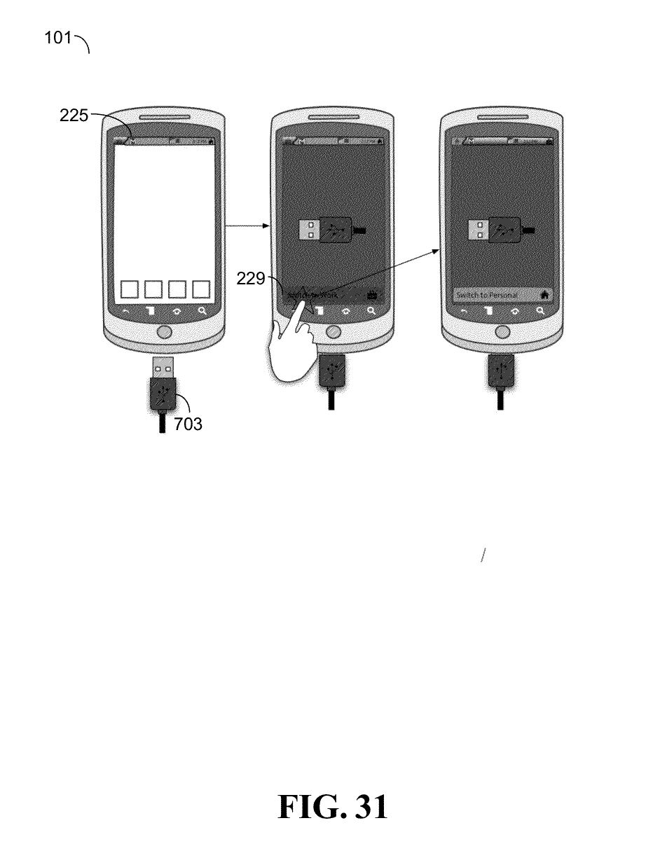

FIG. 31 illustrates another particular, non-limiting embodiment of a system for interfacing with hardware resources in accordance with the teachings herein. The system is illustrated by its renderings on the display of a mobile technology platform 101. This particular embodiment is particular to the Samsung KIES® operating system. However, one skilled in the art will appreciate that this approach may be applied, with suitable modifications (if needed), to any application that mounts and maintains USB connections, such as USB 703 or USB based protocols including, but not limited to, UMS or MTP.

The default behavior of the Samsung GALAXY® S2 when a USB cable 703 is attached is to launch the Samsung KIES® activity (based on MTP). This is a modal activity to the entire device. No other activities can be interacted with while the Samsung KIES® activity is active. To disable the Samsung KIES® mode and resume normal device interaction, the user must press the home key (or turn the device off). The Samsung KIES® 225 will launch when the USB cable 703 is attached only if the mobile technology platform 101 is in idle mode (desktop, applications view and locked mode). It will also pause any running background media such as music. When the Samsung KIES® is launched, it will recognize itself to the host as an MTP device, and it can then be recognized with the Samsung KIES® PC application. If the device is secured (password protected), then Samsung KIES® will launch and connect to the host only after password is authenticated.

In the design of this embodiment, the default behavior of the Samsung KIES® is maintained. There may be a quick persona switch button 229 in the Samsung KIES® activity. Tapping the button 229 will switch to the other persona with the Samsung KIES®. Switching to a secured persona will typically require password authentication first.

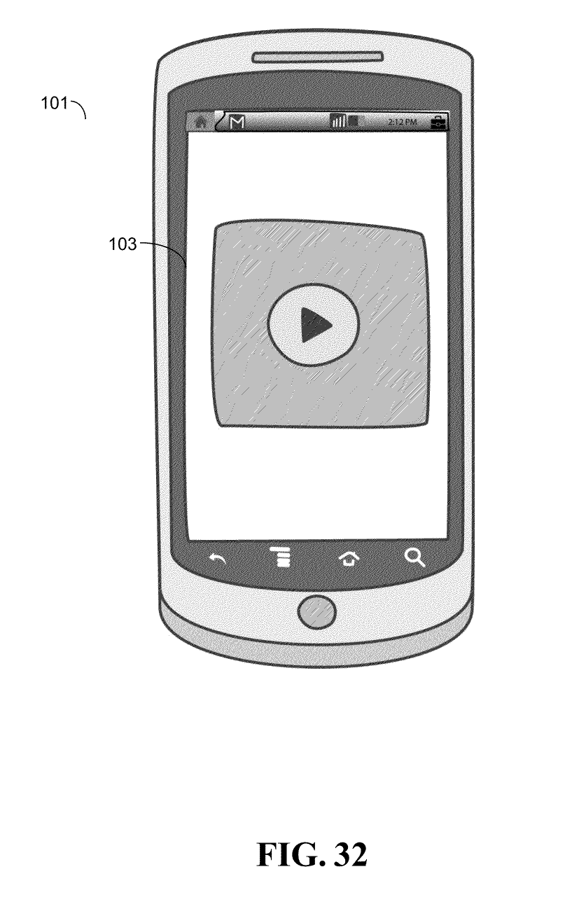

FIG. 32 illustrates a particular, non-limiting embodiment of a method for interfacing with audio hardware resources in accordance with the teachings herein, as illustrated by its renderings on the display 103 of a mobile technology platform 101. In accordance with this particular method, when an audio track has been initiated by some persona, it is preferred that the audio track will continue playing unless it is explicitly stopped, paused or replaced by any other track by any other persona. Hence, it is preferred that switching a persona during audio track play will not stop or pause the track from playing. For example, the default ANDROID® music player has a widget embedded in the notification drawer of the operating system while an audio track is being played. Preferably, the widget follows through all notification drawers in all personas to allow quick access to music controls from any view. Of course, it will be appreciated that a similar procedure may be utilized to accommodate switching personas during phone calls or BLUETOOTH™ interactions.

Audio recording behavior is preferably similar to audio playing in such embodiments. In particular, when an audio recording has been initiated by a persona, it is preferred that the audio recording will continue recording unless explicitly stopped or replaced by another recording by another persona. In particular, it is preferred that switching a persona during some audio recording will not stop the recording.

Audio playing and recording may operate in a mutually exclusive manner, and preferably in a manner that does not result in the loss of data while this exclusivity is being maintained. This approach tightens security issues that may arise if these functionalities are not exclusive (for example, recording a secured persona voicemail from an unsecured persona).

There are at least two approaches which may be utilized for maintaining such exclusivity. The first approach is to allow the most recent request for service to pass through. Consequently, if voice recording is initiated while music is playing, the music will pause until voice recording has terminated. The second approach is to deny the most recent request for service from passing through. Consequently, if voice recording is initiated while music is playing, the recording will not start until the music is paused. The first method is preferred, since it typically maintains a better user flow and does not require the user to search for the recording application, then stop recording, then return to the player application again, and then select play. However, in some implementations, closing the recording service before playing it might not save the accumulated recording data, thus making the second approach necessary for those implementations.

In embodiments such as that depicted in FIG. 32 where a link exists between a peripheral device and a background persona (such as, for example, an audio recording), a notification is preferably provided to the user when such a mode is entered (that is, when the persona which is linked to becomes a background persona). It is also preferred that a clear indication is provided that such a link exists (e.g., that the background persona is recording). The foregoing is desirable for usability, security and privacy.

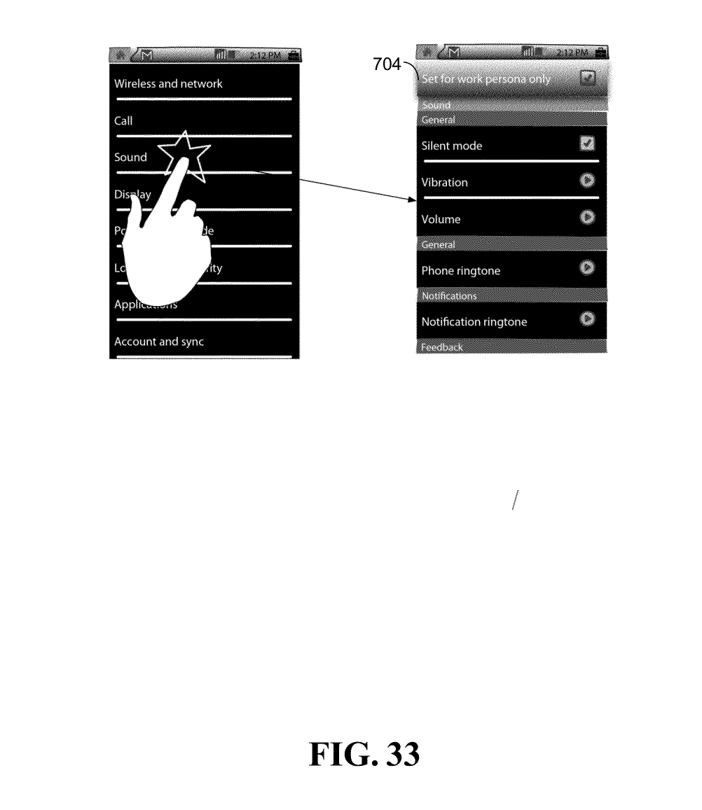

FIG. 33 illustrates a particular, non-limiting embodiment of a method for applying device settings in accordance with the teachings herein. Preferably, in the systems disclosed herein, the user should be able to apply different device settings for each persona, and some device settings should be shared across all personas.

In the system depicted in FIG. 33, in each of the main setting category screens, there is a top bar 704 with a check box that indicates whether the setting category is a common setting or is specific to a particular persona. Tapping on the bar toggles the setting between a persona specific state and a common state. The top bar 704 may have a fixed layout so that all the setting items below it will scroll ‘under’ the bar. A common setting is a setting which is common across all personas, unless otherwise specified by the user. When the user selects to apply a setting category to a specific persona, the setting then branches off of the common setting, and any changes to the setting category will apply to that persona only. When the user unselects the persona specific setting, the settings will reset back to the common setting. If the user reselects the persona-specific settings, the settings will reset to the last values set by that persona.

The foregoing design gives a coarse granularity for persona specific settings. For example, the user here is able to set a specific ringtone for a persona, but is unable to set a common volume for all personas. However, it will be appreciated that systems may be developed in accordance with the teachings herein which support a more refined granularity for settings.

Several variations are possible in the foregoing approach. For example, a top bar 704 may be utilized for even deeper subcategories. Also, color code settings may be utilized which are persona specific. In some implementations, if the user unselects a persona specific setting, the persona-specific setting values will be kept for 2 hours (or so) in case the user would like to revert to the former state.

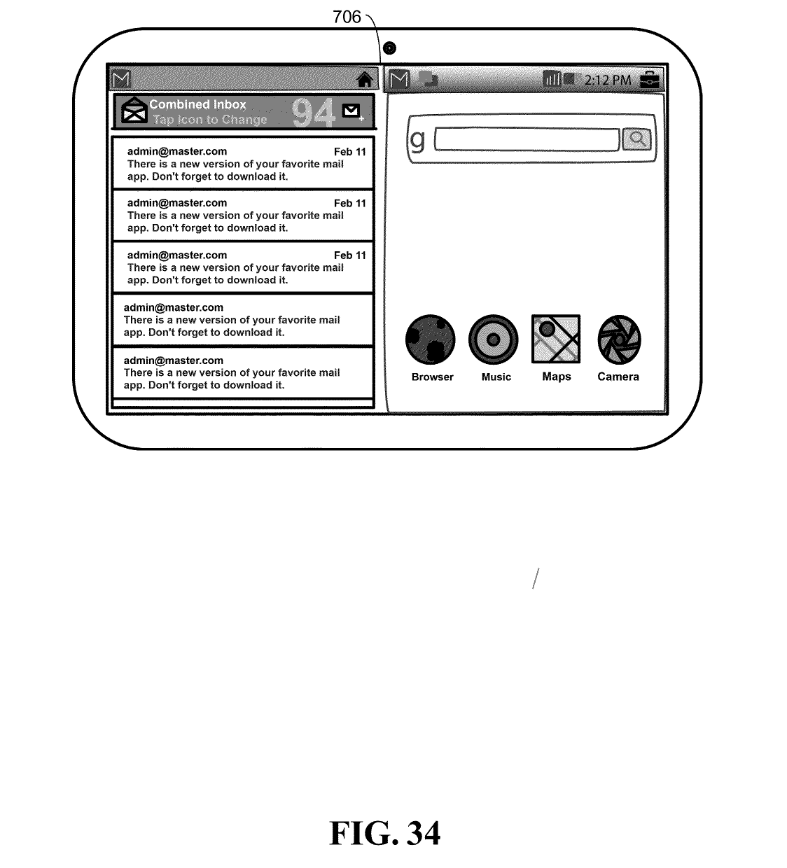

Various split screen personas may be implemented in some of the systems and methodologies described herein. FIG. 34 depicts a particular, non-limiting embodiment of such an arrangement. In the embodiment depicted therein, two personas may be active on one screen using a split screen 706, wherein each part of the screen displays a different persona environment. Having two personas environments displayed on one screen concurrently will increase productivity when using different applications in different personas while still maintaining the environments segregated. Split personas screen 706 and single persona screen should be interchangeable as while split screen 706 mode may increase productivity between personas it may also decrease productivity for a single persona performing a single task as that task is done on less screen real estate.

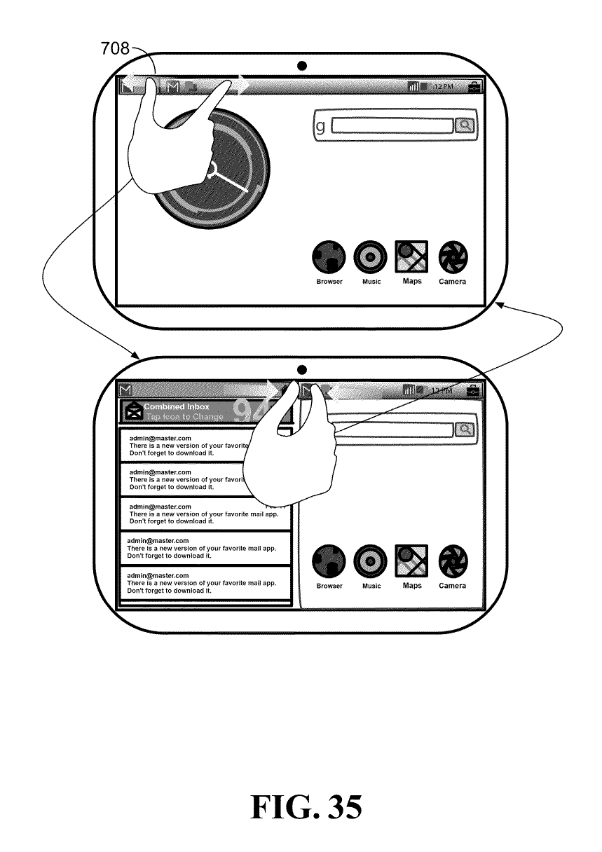

As seen in FIG. 35, moving from single screen persona to split screen personas in such an embodiment may be accomplished by a suitable hand gesture. In the particular, non-limiting embodiment depicted, a spread gesture 708 is utilized for this purpose. Similarly, moving from split screen personas to a single screen persona in such an embodiment may also be accomplished by a suitable hand gesture. In the particular, non-limiting embodiment depicted, a pinch gesture is utilized for this purpose. In other embodiments, contextual menus on the status bars may be utilized to switch between these modes.

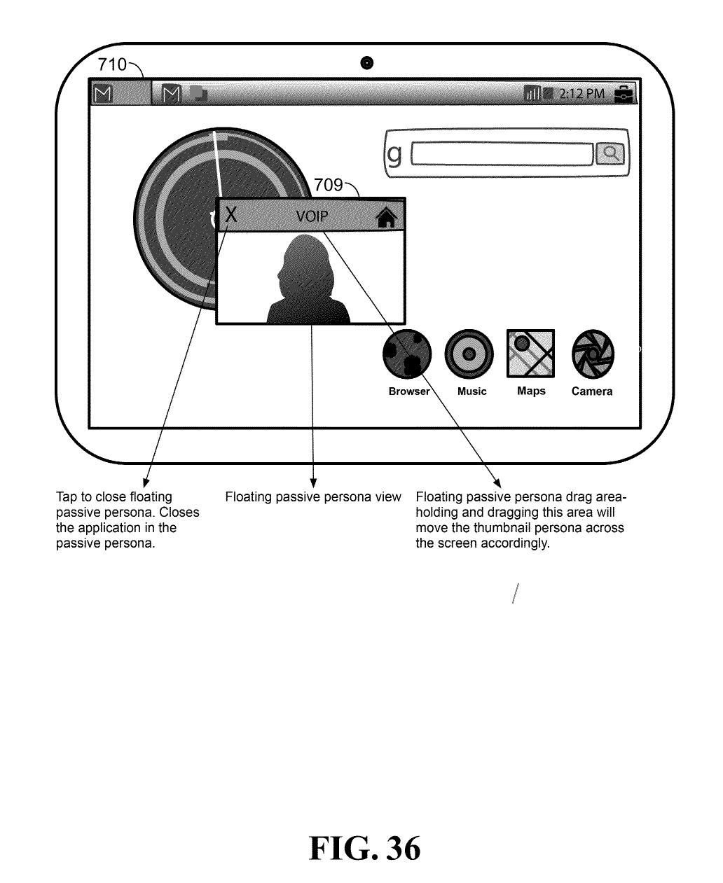

In some embodiments, two personas may be active on a single screen using a persona-in-persona thumbnail view, similar to picture-in-picture, where the active person is displayed across the entire screen area and the passive persona is in a thumbnail sized floating view that can be resized to any screen size. FIG. 36 shows a particular, non-limiting example of such an embodiment.

Having two persona environments displayed on one screen concurrently may increase productivity when using different applications in different personas, while still maintaining segregated environments. The persona-in-persona screen and the single persona screen are preferably interchangeable since, although the split screen mode may increase productivity between personas, it may also decrease productivity for a single persona performing a single task as that task is done on less screen real estate. Dragging and resizing the passive persona 709 floating thumbnail view is preferably enabled, and closing the thumbnail persona may be achieved, for example, by tapping the ‘X’ in the drag area. Closing the floating passive persona will close that application in the passive persona.

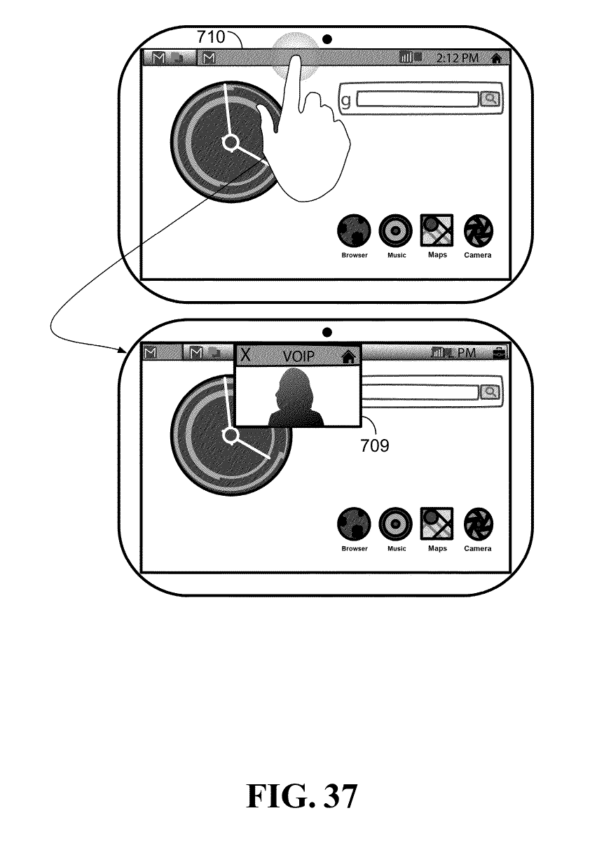

As seen in FIG. 36, moving from single screen persona to persona-in-persona screen mode is preferably accomplished by a long press on the active persona status bar 710. While long pressing on the active persona status bar 710, the passive persona 709 will switch to become the active persona, and a floating thumbnail sized window of the active persona will appear that may preferably be dragged to anywhere in the screen. In FIG. 37, moving from persona-in-persona screen to single screen persona is preferably accomplished by dragging and holding the floating passive persona view 709 on top of the status bar of the active persona 710. In other embodiments, contextual menus on the status bars may be utilized to switch between these modes.

In some embodiments in accordance with the foregoing approach, input with a multi-touch interface may go to both (or multiple) personas at the same time, depending on respective location on the display. In some cases, other sensors may be properly redirected per persona as, for example, through the use of voice commands that start with a prefix that indicates which persona is to be affected. Similarly, radio signals may be equipped with a prefix that encodes the target persona.

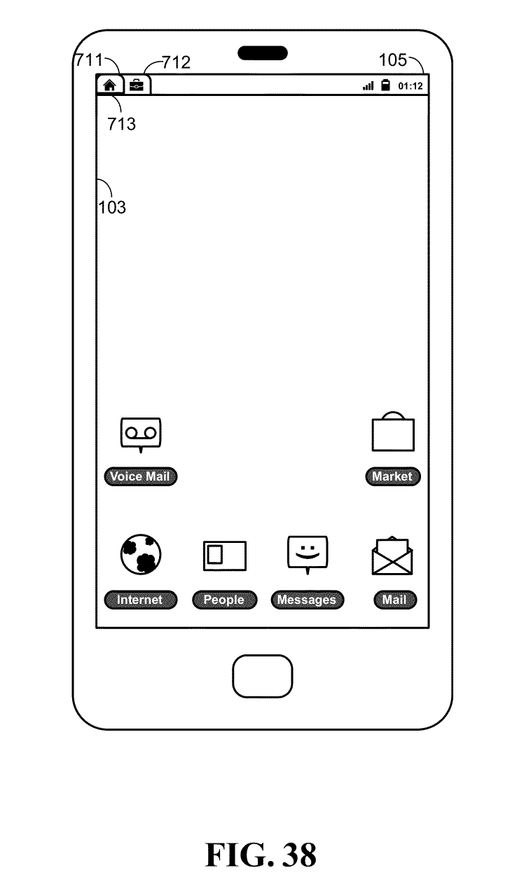

FIG. 38 shows a standard mobile phone device equipped with a display, such as display 103, and having a status bar area, such as, status bar 105 at the top part of the display 103. The right side of the status bar 105 shows the device information such as the device time, battery level and wireless signal strength.

The left side of the status bar includes a tab system showing available personas. In the particular embodiment depicted, the tab system comprises two tabs representing two personas, namely, a personal persona and a business persona. The personal persona is represented by the tab with a home icon 711, while the business persona is represented by a tab with a briefcase icon 712. However, it will be appreciated that these icons may be replaced by any other appropriate icon, image, pattern or any other visual indicator.

In the particular embodiment depicted, the active persona is the personal persona, and it is indicated by the line at the bottom of the tab 713. However, other visual indicators for the active persona may be utilized instead. For example, the active persona icon may be rendered with a saturated color, while the background persona may be rendered with a grey-scale color. The main display area 103 reflects the main display of the active persona (in the embodiment depicted, a desktop or home activity), with icons representing installed applications that are organized on the display 103 by the user.

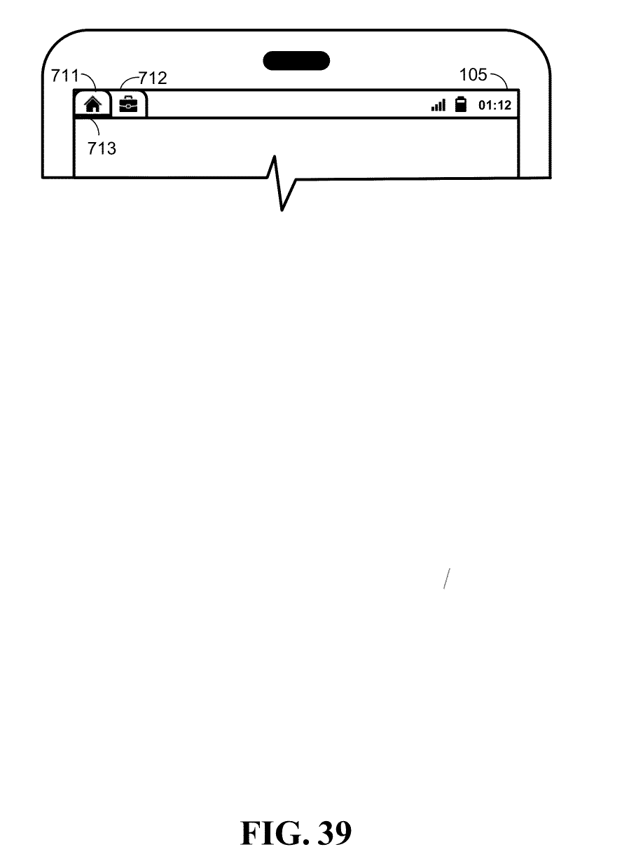

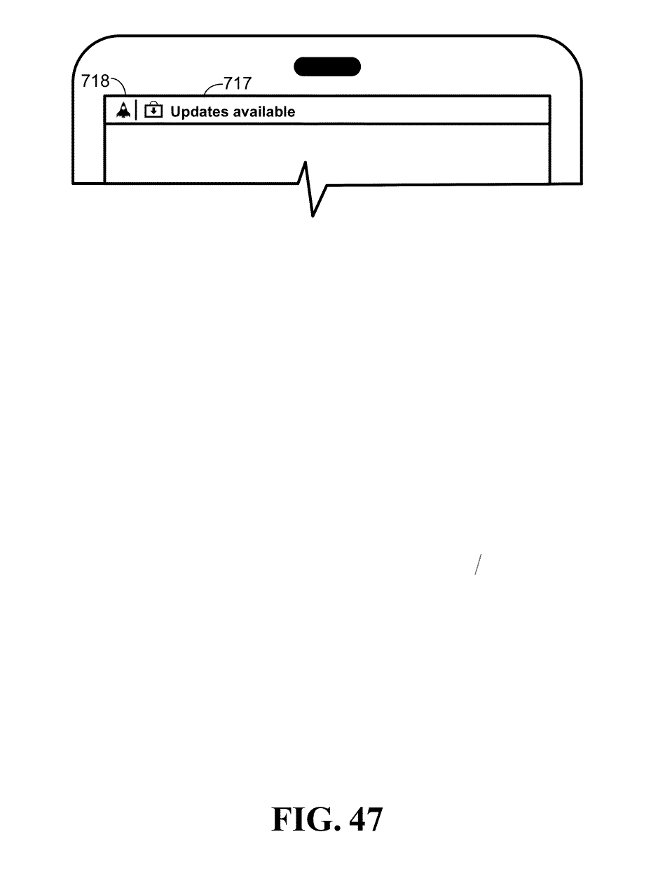

FIGS. 39-47 show portions of a mobile device demonstrating actions occurring in the status bar, such as status bar 105. Thus, FIG. 39 shows a status bar with two tabs representing two personas. The tab on the left with a house icon, such as, icon 711 represents the personal persona, and the tab on the right with a briefcase icon, such as, icon 712 represents the business persona. The highlighted line at the bottom, such as, line 713 of the personal persona icon 711 indicates that the personal persona is the active persona.

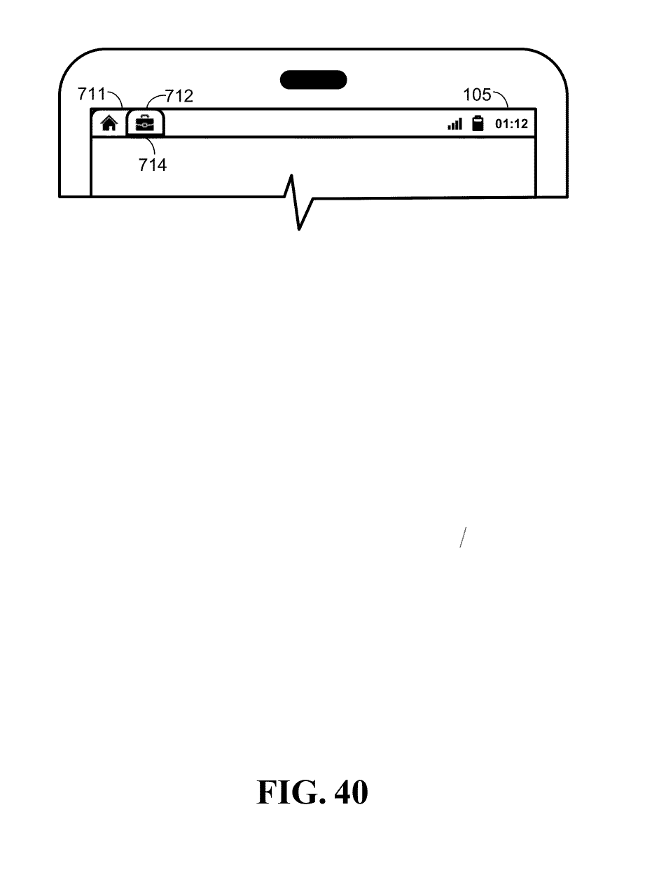

FIG. 40 is similar to FIG. 39, except that the active persona is now the business persona. This is indicated by a highlighted line at the bottom of the business persona icon 712.

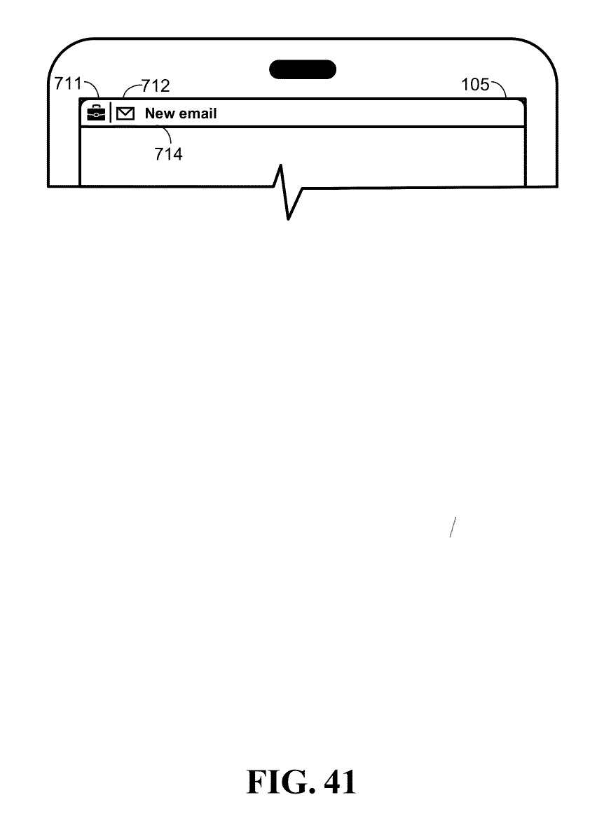

FIG. 41 shows a transient state of a new message alert (notification) 714, in this case, for an incoming email notification received by the business persona. The icon 712 representing the business persona temporarily expands to fill the entire status bar area, overtaking all other tabs and indicators in the status bar. The content of the expanded tab includes a persona indicator (e.g., the persona icon) on the left most part, followed by a line divider which divides the persona indicator from the content of the alert message. The line divider is then followed by the alert icon and the alert message. The alert message may scroll right to left or top to bottom.

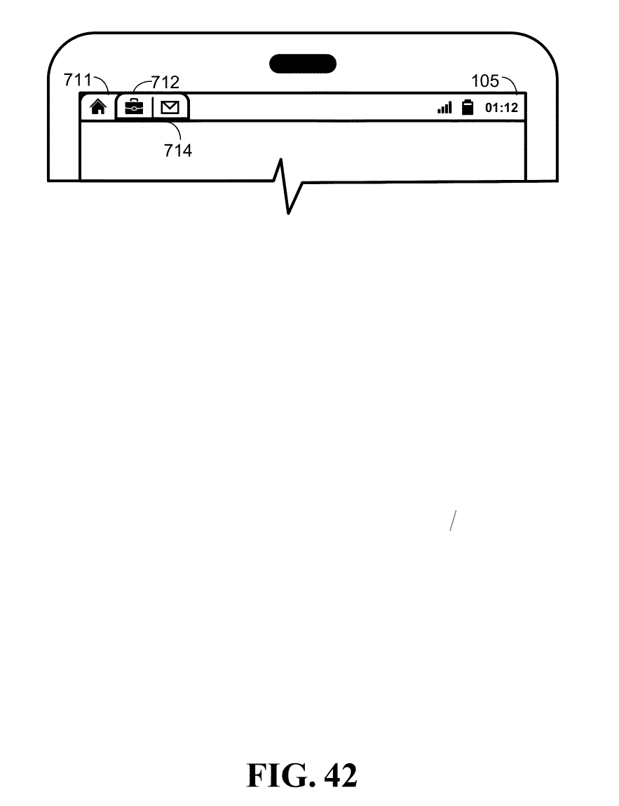

FIG. 42 shows the status quo sometime after the e-mail message alert completes its display. The status bar resumes its initial state with the device status indicators being shown on the right and the persona tabs shown on the left. The business persona tab is now longer than before as it also displays the e-mail notification icon for that persona. The persona tabs remain in their relative positions, but may extend their length to display additional pending notifications. The persona icon, such as, icon 711 and 712 may have a visual divider to separate the icon from the notification icons.

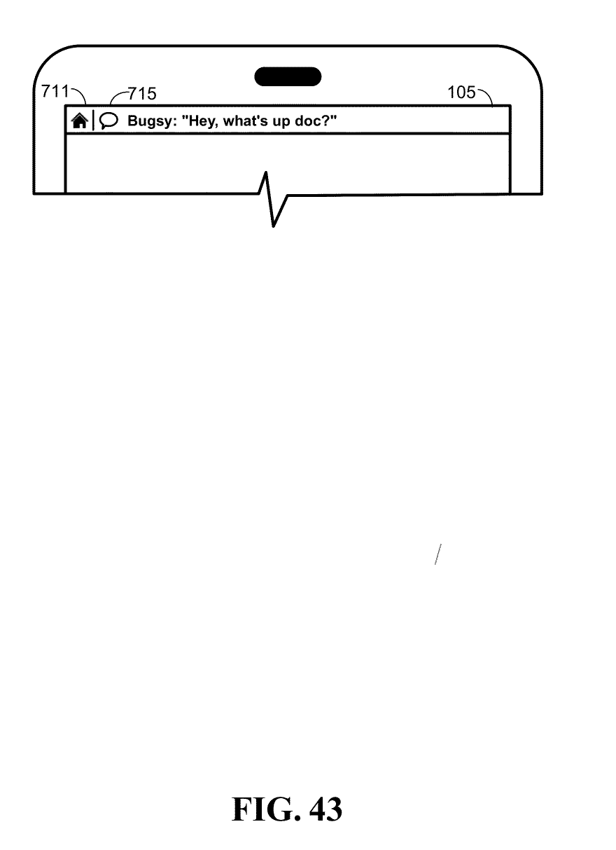

FIG. 43 shows another transient message alert (notification) 715 for incoming chat notification received by the personal persona. The tab representing the personal persona expands to fill the entire status bar area, temporarily removing all other tabs and indicators in the status bar.

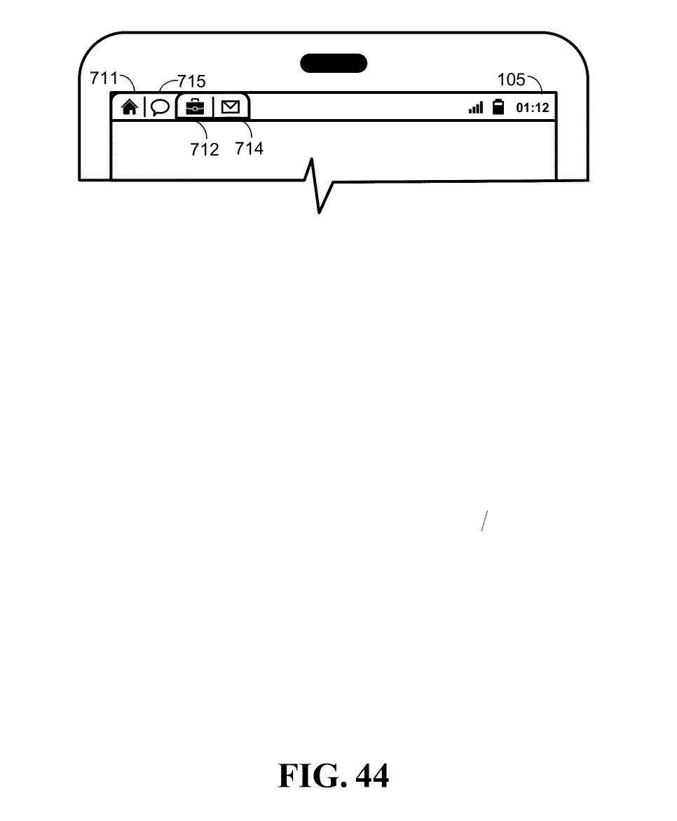

FIG. 44 shows the status quo sometime after the chat message alert completes its display. The status bar resumes its initial state with the device status indicators and the persona tabs being shown. The personal persona tab is now longer than before, as it displays the chat notification icon for that persona. There are now two personas, personal and business personas, each with one pending notification, a chat notification 715 and an email notification 714, respectively.

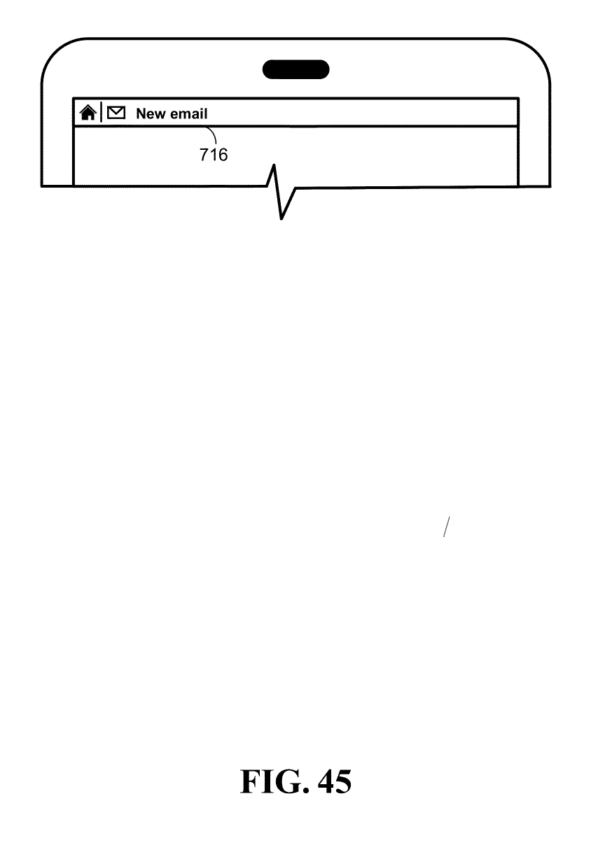

FIG. 45 is similar to FIGS. 41 and 43, and shows another message alert (notification), such as notification 716 for incoming email notification received by the personal persona. The tab representing the personal persona expands to fill the entire status bar area, temporarily removing all other tabs and indicators in the status bar. As indicated, the user is alerted of a new incoming e-mail.

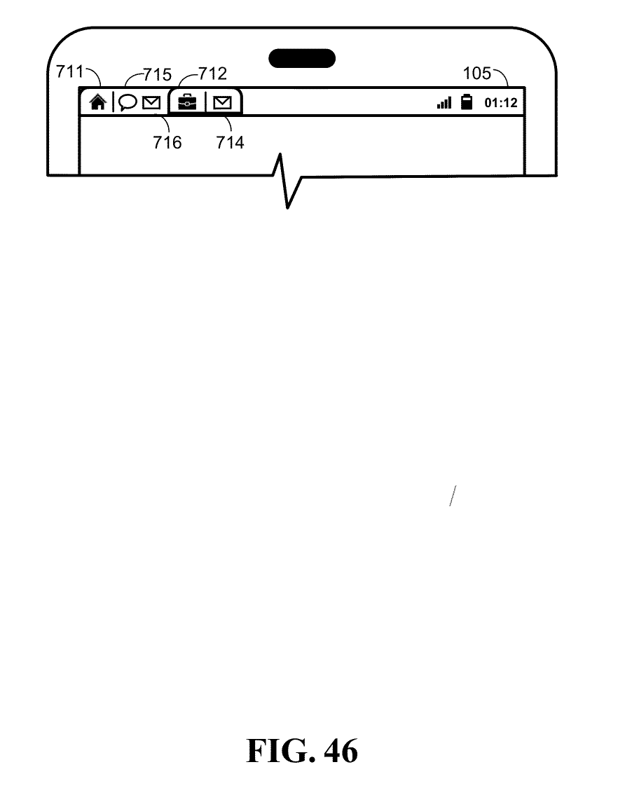

FIG. 46 (similar to FIGS. 42 and 44) shows some time after the e-mail message alert completed its display. The status bar resumes its initial state, with the device status indicators and the persona tabs being shown. The personal persona tab is again longer than before, as it displays the chat notification icon 715 and e-mail notification icon 716 for that personal persona.

FIG. 46 shows a new alert for an available update for an application 717 received by the non-visible gaming persona.

The tab representing the gaming persona 718 was non-visible before (for example, because the user applied a rule on it that hid the persona tab 718 if there are no pending notifications for that persona). When an alert is received for this persona, the corresponding persona tab 718 appears and expands to fill the entire status bar area. As shown, the user is alerted of a new available update for an application in a third, formerly non-visible, persona.

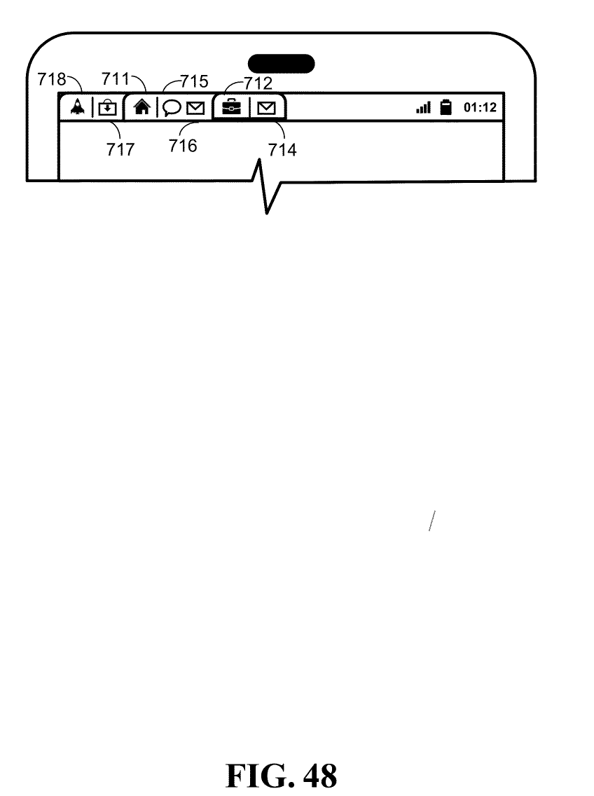

FIG. 48 shows the status quo sometime after the application update alert has completed its display. The status bar resumes its initial state with the device status indicators being shown along with the persona tabs. The gaming persona tab 718 now appears with the application update notification icon 717 for that persona.

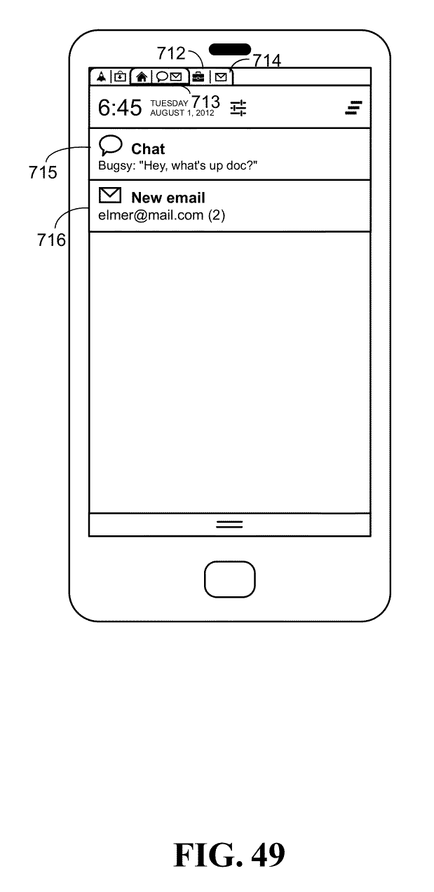

FIG. 49 depicts the notification center with all pending messages for the personal persona. At the top of the device display there are three persona tabs, each with some notification icons. The leftmost tab shows the gaming persona with one pending notification 717 for application updates. The middle tab shows the personal persona with two pending notification icons for email 716 and chat 715. The rightmost persona tab 712 shows the business persona with one pending notification icon 714 for an email message. In the left portion of the figure, the personal persona is the active persona, which is indicated by the enhanced line drawn at the bottom of the tab, such as line 713. However, any other visual indicator to indicate the active persona may apply.

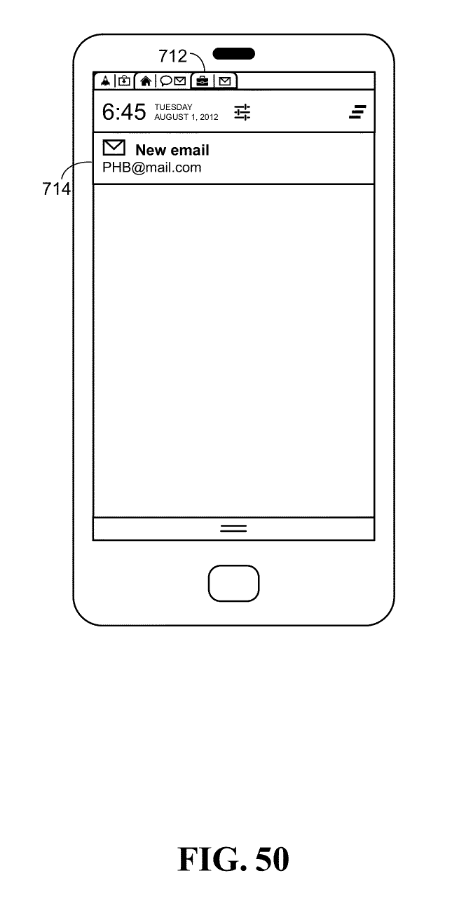

In the main screen area, the details of the pending notification are shown for the personal persona. It is shown that there is a chat message from ‘Bugsy’ and two unread emails from ‘Elmer’. FIG. 50 shows the state of the device after switching to the business persona from the previous state. Switching may be accomplished by a suitable gesture, such as a tap on the target persona tab. Since the notification center was open before the switch, it remains open after the switch by presenting data relevant to the newly active persona. In other words, switching between personas switches between the corresponding notification centers.

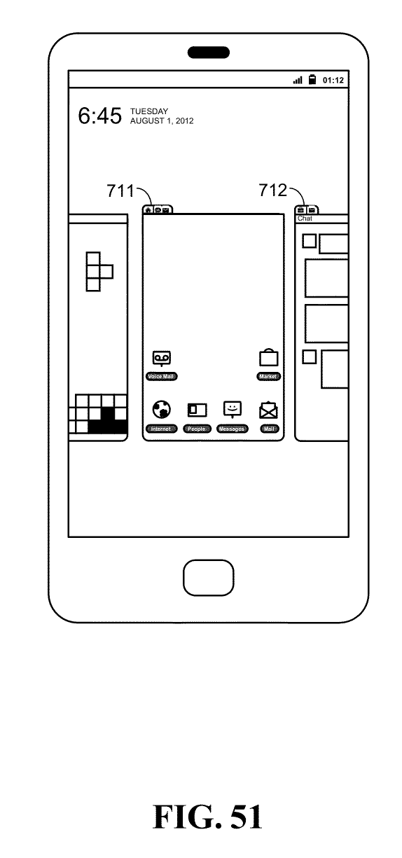

FIG. 51 shows different methods for persona browsing. Persona browsing is a method for browsing all personas by showing indicators of these persona and, optionally, their thumbnail images of their last known display state. The display state may be of a screenshots taken from persona displays the moment each persona was moved from the foreground to the background. The display state for each persona may also be a screenshot of a persona taken the moment the persona browser was composed for display, or may display a real-time feed of the persona display. For example, one of the thumbnails may show a movie clip being played in real-time in one of the personas. Any layout for the persona browsing may be applied.

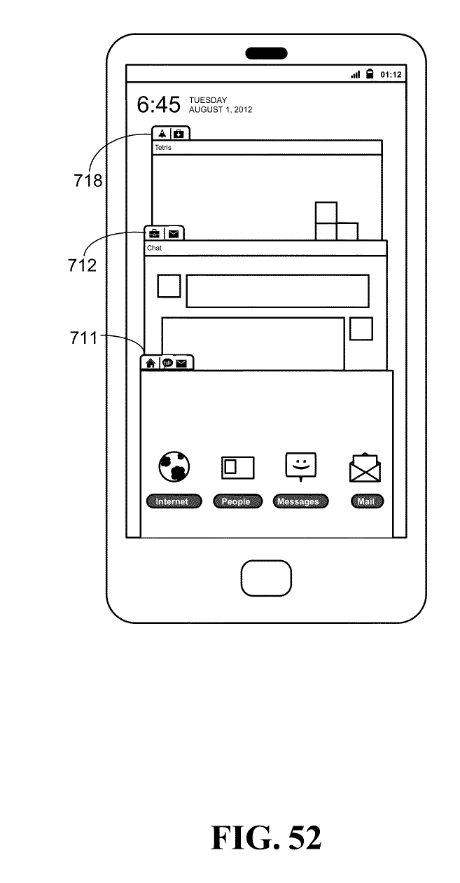

FIG. 52 depicts a horizontal carousel control.

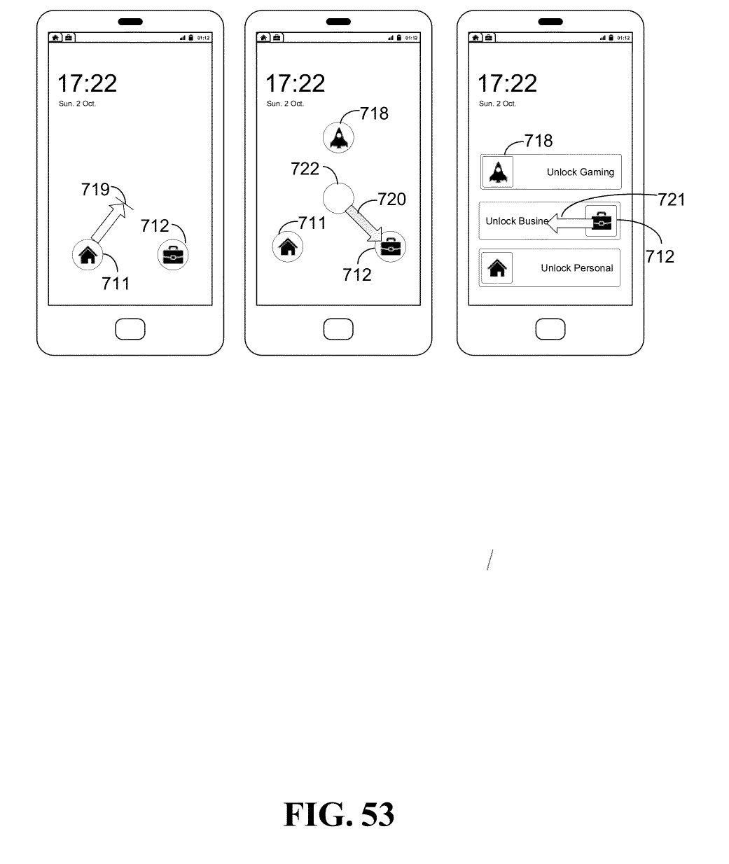

FIG. 53 shows three different methods for unlocking a persona from the lock screen. Arrows 719 through 721, respectively, represents a swiping gesture motion. On the left of FIG. 53, the lock screen presents two icons representing two personas. The home icon 711 on the left represents the personal persona, and the briefcase icon 712 on the right represents the business persona. Like most traditional lock screens, the screen is also composed of a large time display and the date beneath it. To unlock the device into a persona, a finger gesture such as a swipe gesture may be performed which originates from the persona icon to some threshold distance on the screen display. For example, to unlock the screen into the personal persona, the user may put his finger on the home icon and swipe his finger to any direction 719. After swiping has passed some threshold distance, the screen will unlock, and the personal persona will become the active persona.

On the middle of FIG. 53, the lock screen presents three icons representing three personas. The home icon 711 on the left represents the personal persona, and the spaceship icon 718 a gaming persona. In the center between these icons there is a circle 722 signifying where swiping should originate. Swiping from the circle 722 in the middle to any of the persona icons will unlock the device screen into that persona. For example, swiping from the center circle 722 to the business persona icon 712 will unlock the screen, and the business persona will become the active persona.

On the right of FIG. 53, the lock screen presents three icons representing three personas. The home icon 711 on the bottom represents the personal persona, the briefcase icon 712 in the middle represents the business persona, and the spaceship icon 718 on the top represents the gaming persona. A horizontal swipe motion starting from each one of the persona icons will unlock the persona the swipe originated from into that persona. For example, a swipe motion 721 from right to left starting from the business persona icon 712 will unlock the screen, and the business persona will become the active persona.

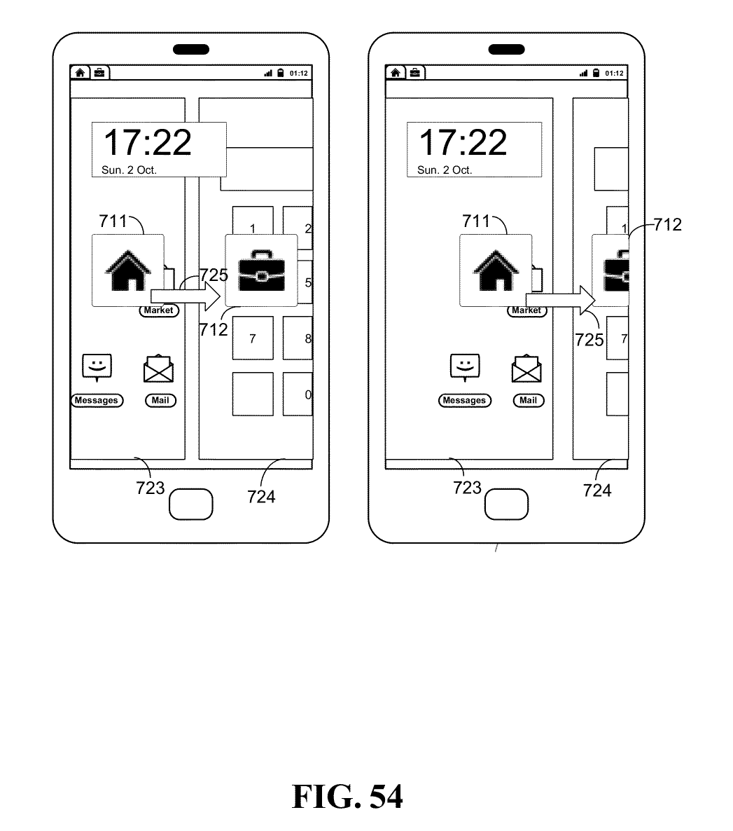

FIG. 54 shows an additional method for unlocking a persona from the lock screen. On the left of FIG. 54, two thumbnail images are shown for each persona with persona icons overlaid on top. The left thumbnail image is the image of the personal persona in its most recent state 723, showing a portion of its home/desktop page. The personal persona icon 711 overlies it. The right thumbnail image is the image of the business persona in its most recent state 724, showing a portion of its PIN lock page. The business persona icon 712 overlies it. The traditional lock screen time and date elements are overlaid over both thumbnail images.

To unlock the personal persona, a swipe gesture must be performed from the left of the screen display to the right 725. To unlock the business persona, a swipe gesture must be performed from the right of the screen display to the left (not shown). The right portion of FIG. 54 demonstrates that the thumbnail images follow the finger during the swipe gesture to the point that the thumbnail fills the entire main screen area.

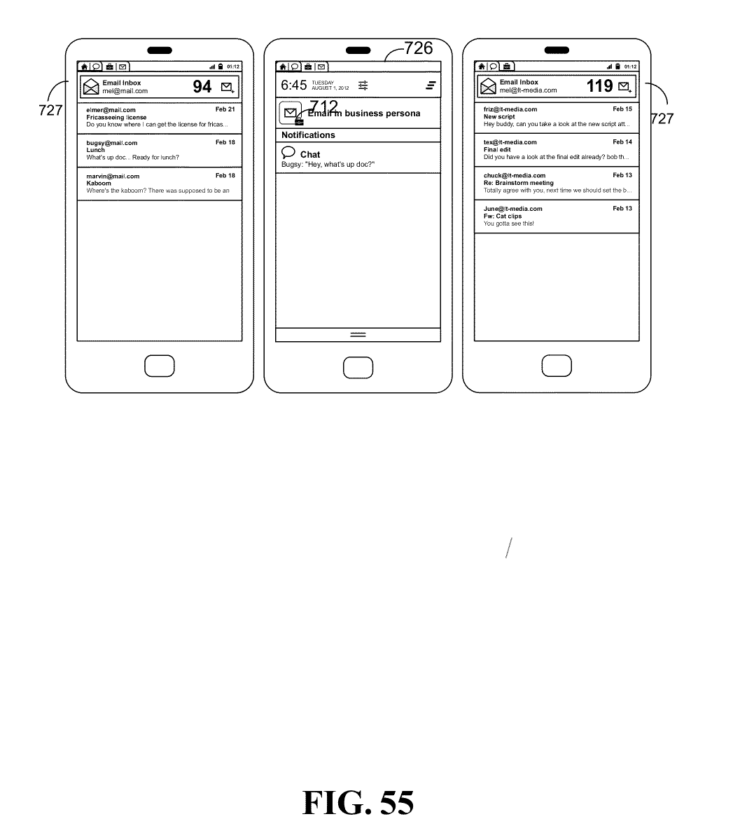

FIG. 55 shows one method for same-app-switching in which the switching option is presented in the notification center area. By selecting the option, a persona switch occurs, and the same app is launched in that persona.

On the left of FIG. 55, it is shown that the personal persona is the active persona and the mail application occupies the entire main screen area. The mail application consists of a header area at the top of the main screen area showing that the application displays the inbox page of the email, the mail account is owned by mel@mail.com. On the right side of the header there is the number ‘94’ signifying the number of unread mails for that account. Under the header area, three email messages are displayed in a vertical list.

On the middle of FIG. 55 is shown a modified notification center of the personal persona in the main screen area. At the top part of the notification center is the header 726 that consists of the time and date and other optional button areas. Underneath the header area 726 there exists a same-app-switch suggestion area 727. The area is optional and is only displayed if the same foreground application in a persona exists in other personas.

In this embodiment, an email icon ID 714 is presented which signifies the icon of the foreground application. The email icon 714 is overlaid with a briefcase icon 712, which signifies that the same application exists in the business persona. The composite icon is then followed, to the right, with a text message that hints to an email application in the business persona.

Other such items may exist in a vertical or horizontal list for each background persona that has the same application installed. Tapping on the same-app-switch suggestion item 727 will switch to the persona the item refers to and launch the same application the in that persona. If the same app is not available in the target persona, the system may still suggest an equivalent or related application that may be a good substitute and address the intent of the user.

On the right of FIG. 55 is shown the result of tapping on the same-app-switch Item 727. As seen therein, the business persona is now the active persona, and the mail application occupies the entire main screen area. The mail application consists of a header area at the top of the main screen area showing that the application displays the inbox page of the email. The mail account is owned by mel@it-media.com, which is the user's business email. On the right side of the header there is the number ‘119’ which signifies the number of unread mails for that account. Under the header area, four email messages are displayed in a vertical list.

By comparing the left of FIG. 55 to the right of FIG. 55, it is apparent that the email application is the foreground application in each case. The applications look similar, but each application shows an email inbox view of a different email account that is defined in a different persona.

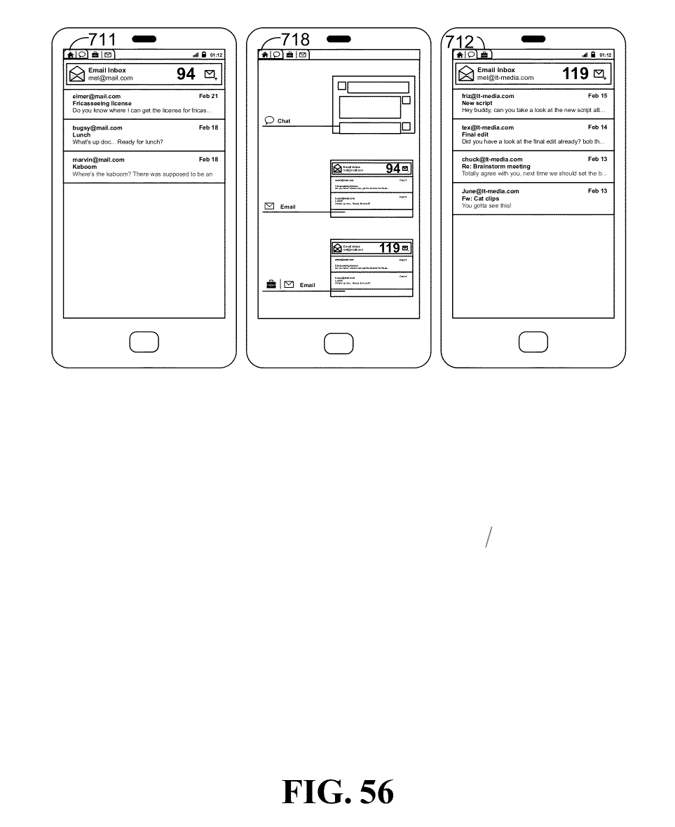

FIG. 56 shows another method for same-app-switching. FIG. 56 is similar to FIG. 55 above. The right and left of FIG. 56 are the same, but the middle of FIG. 56 is different.

A modified “recent activity screen” is shown in the middle of FIG. 56. The recent activity screen is composed of a vertical item list of the most recent activities, where each item consists of the application icon, application name and an application thumbnail image of its most recent known state. The first two items at the top of the screen are the most recent applications that were active in the personal persona, which is the active persona in this embodiment. The items show that the most recent active applications were the chat application (on the top) and the email application (in the middle). The item in the bottom shows a slightly different item view, and it can be seen that there is a briefcase icon 712 to the right of the email icon. The briefcase icon 712 in this view signifies that an email application also exists in the business persona. Additional items of this nature may exist if other personas have the email application installed. By tapping on that bottom item, the business persona will become the active persona, and the email application in the business persona will launch.

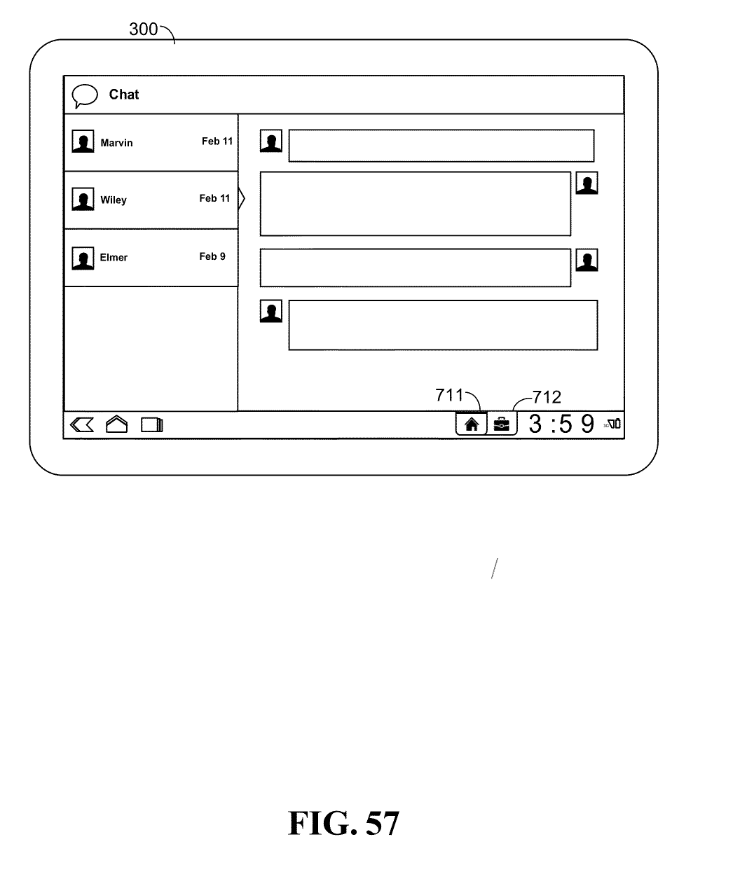

FIG. 57 shows persona tabs on a tablet device 300. The main screen display on the tablet device 300 shows a chat conversation happening between the device owner and Wiley. The persona tabs are located in the status bar area of the tablet device 300, which is located, in this tablet design, at the bottom of the screen area. As depicted, there are two personas in this embodiment, namely, personal and business personas with similar indications as detailed in the embodiments described above. It is apparent that the personal persona is the active persona, as it is indicated by the line at the top part of the personal persona tab.

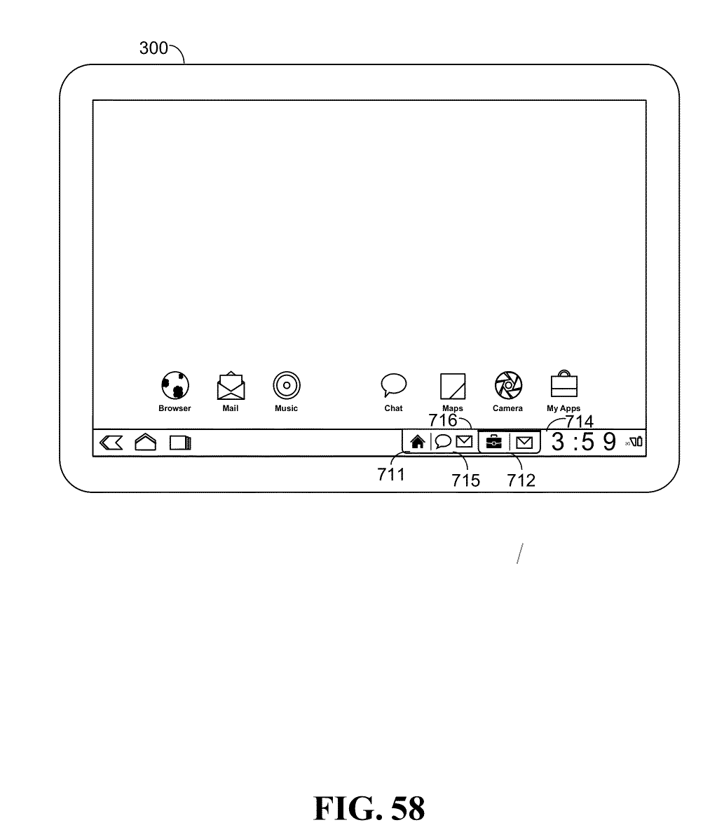

FIG. 58 shows persona tabs on a tablet device, such as tablet device 300 where each persona has pending notifications. The main screen display of the tablet device 300 shows the traditional home/desktop screen of the business persona. As in FIG. 57, the persona tabs are located in the status bar area of the tablet device. However, in the embodiment of FIG. 58, each persona has pending notifications. Thus, for example, the personal persona has a chat notification icon 715 and e-mail notification icon 716 within the persona tab, and the business persona has a pending e-mail notification. It is apparent that the business persona is the active persona, as indicated by the line at the top part of the business persona tab.

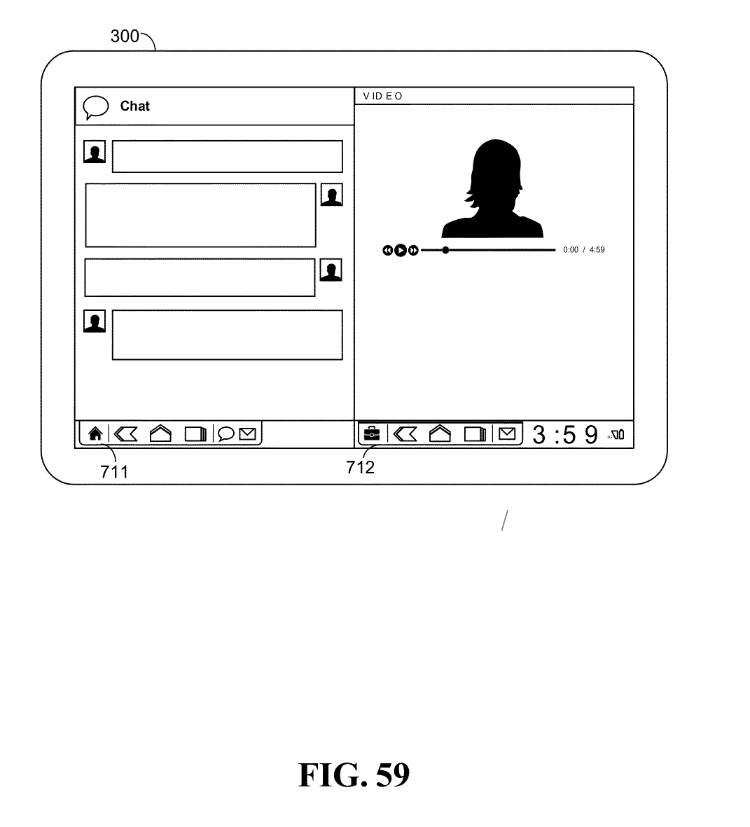

FIG. 59 shows two personas side-by-side (partitioning). In this example, each persona occupies half of the main screen area displaying their screen display respectively (but other splits may be possible). In this example, the personal persona is engaged in a chat activity, while the business persona has a video clip playing in it. The status bar area is also split equally amongst the display area of the two personas. Each persona's status bar area is present at the bottom of the main screen display area of each persona. Each persona status bar area displays the persona icon 711 or 712, the persona main navigation controls (such as the back, home and recent applications), and the pending notifications for the persona. Device status information, such as the clock and wireless signal strength, are fixed to their location, and share the area with the rightmost persona status bar.

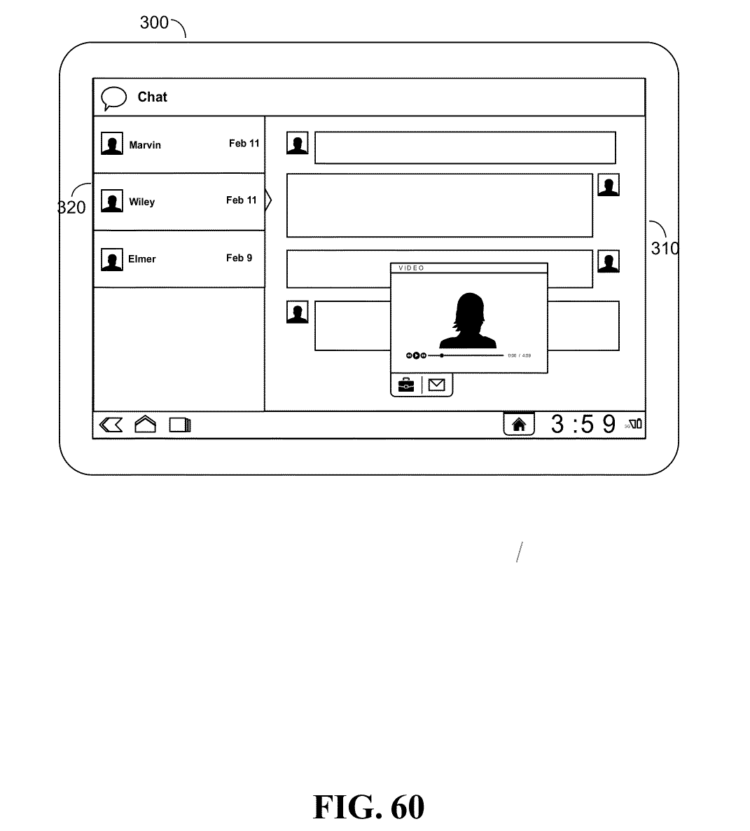

FIG. 60 shows two personas in an embodiment where one persona screen display 310 occupies some part of the device screen display and is overlaid on top of another persona screen display 320, the latter of which is spread along the device screen display (embedding). In this embodiment, the business persona is overlaid on top the personal persona. The business persona is playing a video clip, while the personal persona is displaying a chat view of a chat application. As depicted, the personal persona tab is located inside the device status bar area, while the overlaid persona has its status tab attached to the bottom of its display.

Several modifications and variations are possible with respect to the systems and methodologies described above. For example, while these systems and methodologies have frequently been described with respect to their implementation on mobile communications devices, one skilled in the art will appreciate that these systems and methodologies may also be implemented on various other mobile technology platforms including, but not limited to, book readers (such as Amazon's KINDLE® book reader), displays, and various types of mobile computers.

Moreover, any of the methodologies disclosed herein may be implemented as a software program which is disposed in a tangible, non-transient medium, and which contains suitable programming instructions which, when executed, cause the method to be carried out. Such a medium may be associated with, or disposed within, a mobile technology platform.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A mobile technology platform equipped with a display and a processor, comprising:
an operating system executed by the processor; and
a software program configured to run on the operating system, wherein the software program is further configured to establish a plurality of personas for a user of the mobile technology platform, wherein each of the plurality of personas has a unique set of user preferences associated with a persona, each of the unique set of user preferences corresponds to a unique execution environment, wherein the software program is further configured to establish a first display portion comprising a first persona environment and a second display portion comprising a second persona environment, wherein the first and second persona execution environments do not overlap.

2. The mobile technology platform of claim 1, wherein the first and second persona execution environments are concurrently active.

3. The mobile technology platform of claim 1, wherein the first and second persona execution environments are independently active.

4. The mobile technology platform of claim 1, wherein the mobile technology platform is switchable between a first state in which the first and second persona execution environments are concurrently active, and a second state in which only one of the following is active: the first persona environment, and the second persona environment.

5. The mobile technology platform of claim 4, wherein the mobile technology platform is switchable from the first state to the second state by a spreading hand gesture.

6. The mobile technology platform of claim 3, wherein the mobile technology platform is switchable from the second state to the first state by a pinching hand gesture.

7. The mobile technology platform of claim 1, wherein the second persona environment is displayed within the first persona environment.

8. The mobile technology platform of claim 7, wherein the first persona environment is active, and wherein the second persona environment is passive.

9. The mobile technology platform of claim 8, wherein the mobile technology platform is switchable from the first persona environment and the second persona environment upon launching of an application through a respective application icon displayed in the first persona environment, wherein the application is launched in the second persona environment.

10. The mobile technology of claim 9, wherein the application is launched in response to a single hand gesture.

11. The mobile technology platform of claim 1, wherein the mobile technology platform is switchable between a first state in which the second persona environment is disposed within the first persona environment, and a second state in which only the first persona environment is displayed.

12. The mobile technology platform of claim 1, wherein each of the first persona environment and the persona environment is any one of: operating system, a sandbox, a userspace container, and a hypervisors.

13. A method for implementing multiple personas in a mobile technology platform, comprising:
establishing a plurality of personas for a user of the mobile technology platform, wherein each of the plurality of personas has a unique set of user preferences associated with a persona, each of the unique set of user preferences corresponds to a unique execution environment;
establishing a first display portion comprising a first persona environment and a second display portion comprising a second persona environment, wherein the first and second persona execution environments do not overlap.

14. The method of claim 13, wherein the first and second persona execution environments are concurrently active.

15. The method of claim 13, wherein the first and second persona execution environments are independently active.

16. The method of claim 13, further comprising:
switching between a first state in which the first and second persona execution environments are concurrently active to a second state in which only one of the following is active: the first persona environment, and the second persona execution environment.

17. The method of claim 16, wherein the switching between the first state and the second state occurs in response to a spreading hand gesture.

18. The method of claim 16, wherein the switching between the second state and the first state occurs when at the event of at least a pinching hand gesture.

19. The method of claim 17, wherein the second persona environment is disposed within the first persona environment.

20. The method of claim 19, wherein the first persona environment is active, and wherein the second persona environment is passive.

21. The method of claim 19, wherein the mobile technology platform is switchable from the first persona environment and the second persona environment upon launching of an application through a respective application icon displayed in the first persona environment, wherein the application is launched in the second persona environment.

22. The method of claim 21, wherein the application is launched in response to a single hand gesture.

23. The method of claim 13, further comprising:
switching between a first state in which the second persona environment is disposed within the first persona environment, and a second state in which only the first persona environment is displayed.

24. The method of claim 13, wherein each of the first persona environment and the persona environment is any one of: operating system, a sandbox, a userspace container, and a hypervisors.

25. A non-transitory computer readable medium having stored thereon instructions for causing one or more processing units to execute the method according to claim 13.
